(19) United States
(12) Patent Application Publication
(10) Pub. No.: US 2018/0136659 A1
(43) Pub. Date: May 17, 2018

(54) MOTION ACTIVATED FLYING CAMERA SYSTEMS

(71) Applicant: Rooftop Group International Pte. Ltd., Singapore (SG)

(72) Inventor: Darren Matloff, Houston, TX (US)

(21) Appl. No.: 15/811,299

(22) Filed: Nov. 13, 2017

Related U.S. Application Data
(60) Provisional application No. 62/422,516, filed on Nov. 15, 2016.

(51) Int. Cl. G05D 1/00; B64D 43/02; B64C 39/02

(52) U.S. Cl. CPC G05D 1/0094; B64D 43/02; B64C 2201/145; B64C 2201/127; B64C 2201/146; B64C 39/024

(57) ABSTRACT

A remotely controlled flying camera system can to disable recording and/or streaming by a camera system on a flying device based on one or more programmed criteria. The programmed criteria can be based on predictions of when the flying camera system is likely being used as a surveillance camera and/or in situations that can result in an invasion of privacy. The predictions can be based on movements of the flying device and/or the surrounding. The system can reduce privacy invasion concerns with the use of the flying camera system, without completely removing or disabling the associated camera system.

### CROSS-REFERENCE TO RELATED APPLICATIONS

This application claims the benefit of U.S. Provisional Application No. 62/422,516, filed Nov. 15, 2016, titled “MOTION ACTIVATED FLYING CAMERA SYSTEMS,” which is incorporated by reference herein in its entirety.

### FIELD

The disclosure relates generally to the field of remote control flying systems, and more particularly, to systems and methods of flying systems comprising one or more cameras.

### BACKGROUND

Remote control devices are commonly used for recreation and other purposes. Various remote control airplanes, helicopters, quadcopters, and the like are available on the market. With increasing miniaturization of electronics and development of new battery and motor technologies, such devices have become cheaper to manufacture, more reliable, and more popular.

Some such devices are making their way into commercial uses and other non-toy uses, such as for aerial photography, search and rescue, package delivery, and the like. High resolution photography and video recording are becoming popular among these remote-controlled flying device systems. The flying device systems with high resolution cameras can take photographs and/or videos from vantage points that are previously unavailable to the general population and/or prohibitively expensive, for example, requiring the use of a helicopter.

### SUMMARY

The miniaturization of electronics has led to the implementation of more advanced camera systems in the remote controlled flying device systems. However, the ability to take and record video with ease from any vantage point in space has led to a concern over privacy invasion, such that people are worried they can be monitored and/or recorded when they expect not to be. It is desirable to limit flying devices' ability to record in situations likely to result in an invasion of privacy, without completely removing or disabling the associated camera system. It is also desirable to limit flying devices' ability to record without compromising the safety of an airborne flying device.

The disclosure herein relates to flying camera systems, such as systems including remotely controlled and/or autonomous flying devices having a camera and a control system capable of preventing the camera from recording video, taking a picture, and/or streaming a video under certain conditions. The conditions can include if the remote controlled flying device, such as a quadcopter, drone, helicopter, and/or the like, is moving below a certain threshold speed, is moving below the threshold for a predetermined amount of time, is moving below a threshold altitude, if the camera is detecting human presence, other conditions, or any combinations thereof. Such control systems can be desirable, for example, as a privacy measure, to reduce the likelihood of and/or prevent a flying device from intruding privacy.

A remotely controlled flying video recording system in accordance with the present disclosure can comprise a body having one or more propulsion units coupled thereto for causing flight of the remotely controlled flying video recording system; a radio receiver configured to receive command signals from a remote transmitter, the command signals comprising at least flight control data configured to adjust operation of the one or more propulsion units; a camera configured to capture video; an electronic memory controller configured to be electronically coupled to an electronic memory for storing video captured by the camera on the electronic memory; a radio transmitter configured to stream video captured by the camera to a remote video display device; a speed sensor configured to detect a speed of the remotely controlled flying video recording system; and a video controller configured to communicate with the speed sensor to monitor the speed of the remotely controlled flying video recording system, compare the speed of the remotely controlled flying video recording system to a threshold speed level, and responsive to determining the speed is below the threshold speed level, disable storing of video captured by the camera on the electronic memory.

In some embodiments of the remotely controlled flying video recording system, the video controller can be further configured to, responsive to determining the speed is below the threshold speed level, cause the radio transmitter to transmit to the remote video display device an indication that storing of video has been disabled.

In some embodiments of the remotely controlled flying video recording system, the video controller can be configured to enable the radio transmitter to continue streaming video captured by the camera to the remote video display device, even if the video controller has disabled storing of video captures by the camera on the electronic memory.

In some embodiments of the remotely controlled flying video recording system, the video controller can be further configured to monitor an amount of time the speed has been below the threshold speed level; compare the amount of time the speed has been below the threshold speed level to a recording time delay; and responsive to determining the speed is below the threshold speed level, disable storing of video captured by the camera on the electronic memory only if the amount of time the speed has been below the threshold speed level exceeds the recording time delay.

In some embodiments of the remotely controlled flying video recording system, the video controller can be further configured to compare the amount of time the speed has been below the threshold speed level to a streaming time delay, the streaming time delay being greater than the recording time delay; and responsive to determining the speed is below the threshold speed level and that the amount of time the speed has been below the threshold speed level exceeds the streaming time delay, disable the radio transmitter from streaming video captured by the camera to the remote video display device.

In some embodiments of the remotely controlled flying video recording system, the video controller can be further configured to compare the amount of time the speed has been below the threshold speed level to a streaming time delay, the streaming time delay being greater than the recording time delay; and responsive to determining the speed is below the threshold speed level and that the amount of time the speed has been below the threshold speed level exceeds the streaming time delay, cause the radio transmitter to stream an obscured version of video captured by the camera to the remote video display device, wherein the obscured version can comprise one or more of the following: a reduced-quality version of the video captured by the camera, or a watermarked version of the video captured by the camera.

In some embodiments of the remotely controlled flying video recording system, the video controller can be further configured to analyze video captured by the camera to detect whether a human is present in the video captured by the camera; and responsive to determining the speed is below the threshold speed level, disable storing of video captured by the camera on the electronic memory only if a human is present in the video captured by the camera.

In some embodiments of the remotely controlled flying video recording system, the system can further comprise an altitude sensor configured to detect an altitude of the remotely controlled flying video recording system; and the video controller can be further configured to communicate with the altitude sensor to monitor the altitude of the remotely controlled flying video recording system; compare the altitude of the remotely controlled flying video recording system to a threshold altitude level; and responsive to determining the speed is below the threshold speed level, disable storing of video captured by the camera on the electronic memory only if the altitude of the remotely controlled flying video recording system is below the threshold altitude level.

In some embodiments of the remotely controlled flying video recording system, the speed sensor can comprise a Global Positioning System (GPS) sensor, a pressure sensor, an optical sensor, and/or an accelerometer.

In some embodiments of the remotely controlled flying video recording system, the system can further comprise the electronic memory.

In some embodiments of the remotely controlled flying video recording system, the radio transmitter and radio receiver can be part of a radio transceiver.

In some embodiments of the remotely controlled flying video recording system, the command signals can further comprise a request from the remote transmitter to begin storing of video captured by the camera on the electronic memory, and the video controller can be further configured to, responsive to determining the speed is below the threshold speed level, cause transmission to the remote transmitter data indicating the request to begin storing of video captured by the camera has been denied.

In some embodiments of the remotely controlled flying video recording system, the remote transmitter can comprise the remote video display device.

In some embodiments of the remotely controlled flying video recording system, the one or more propulsion units can comprise at least four propulsion units, and each of the one or more propulsion units can comprise at least one motor and at least one propeller.

In some embodiments of the remotely controlled flying video recording system, the video controller can comprise a computer processor separate from second computer processor configured to perform flight control functions of the remotely controlled flying video recording system.

In some embodiments of the remotely controlled flying video recording system, the video controller can comprise a computer processor that can also be configured to perform flight control functions of the remotely controlled flying video recording system.

A remotely controlled flying video recording system in accordance with the present disclosure can comprise a body having one or more propulsion units coupled thereto for causing flight of the remotely controlled flying video recording system; a radio receiver configured to receive command signals from a remote transmitter, the command signals comprising at least flight control data configured to adjust operation of the one or more propulsion units; a camera configured to capture video; a radio transmitter configured to stream video captured by the camera to a remote video display device; and a video controller configured to receive output of signals indicative of a speed of the remotely controlled flying video recording system, compare the speed of the remotely controlled flying video recording system to a threshold speed level, and responsive to determining the speed is below the threshold speed level, disable storing of video captured by the camera on an electronic memory.

In some embodiments of the remotely controlled flying video recording system, the video controller can be further configured to, responsive to determining the speed is below the threshold speed level, cause the radio transmitter to transmit to the remote video display device an indication that storing of video has been disabled.

In some embodiments of the remotely controlled flying video recording system, the video controller can be configured to enable the radio transmitter to continue streaming video captured by the camera to the remote video display device, even if the video controller has disabled storing of video captures by the camera on the electronic memory.

In some embodiments of the remotely controlled flying video recording system, the video controller can be further configured to monitor an amount of time the speed has been below the threshold speed level; compare the amount of time the speed has been below the threshold speed level to a recording time delay; and responsive to determining the speed is below the threshold speed level, disable storing of video captured by the camera on the electronic memory only if the amount of time the speed has been below the threshold speed level exceeds the recording time delay.

In some embodiments of the remotely controlled flying video recording system, the video controller can be further configured to compare the amount of time the speed has been below the threshold speed level to a streaming time delay, the streaming time delay being greater than the recording time delay; and responsive to determining the speed is below the threshold speed level and that the amount of time the speed has been below the threshold speed level exceeds the streaming time delay, disable the radio transmitter from streaming video captured by the camera to the remote video display device.

In some embodiments of the remotely controlled flying video recording system, the video controller can be further configured to compare the amount of time the speed has been below the threshold speed level to a streaming time delay, the streaming time delay being greater than the recording time delay; and responsive to determining the speed is below the threshold speed level and that the amount of time the speed has been below the threshold speed level exceeds the streaming time delay, cause the radio transmitter to stream an obscured version of video captured by the camera to the remote video display device, wherein the obscured version can comprise one or more of the following: a reduced-quality version of the video captured by the camera, or a watermarked version of the video captured by the camera.

In some embodiments of the remotely controlled flying video recording system, the video controller can be further configured to analyze video captured by the camera to detect whether a human is present in the video captured by the camera; and responsive to determining the speed is below the threshold speed level, disable storing of video captured by the camera on the electronic memory only if a human is present in the video captured by the camera.

In some embodiments of the remotely controlled flying video recording system, the system can further comprise an altitude sensor configured to detect an altitude of the remotely controlled flying video recording system; and the video controller can be further configured to communicate with the altitude sensor to monitor the altitude of the remotely controlled flying video recording system; compare the altitude of the remotely controlled flying video recording system to a threshold altitude level; and responsive to determining the speed is below the threshold speed level, disable storing of video captured by the camera on the electronic memory only if the altitude of the remotely controlled flying video recording system is below the threshold altitude level.

In some embodiments of the remotely controlled flying video recording system, the output of signals indicative of the speed of the remotely controlled flying video recording system can comprise signals from a motion sensor, an optical sensor, a pressure sensor, a video feed from the camera, a propulsion unit power and/or current output, user input on a remote control device, and/or any combination thereof. In some embodiments of the remotely controlled flying video recording system, the motion sensor can comprise electrical and/or mechanical sensors. In some embodiments of the remotely controlled flying video recording system, the motion sensor can comprise a Global Positioning System (GPS) sensor or an accelerometer.

In some embodiments of the remotely controlled flying video recording system, the system can further comprise the electronic memory.

In some embodiments of the remotely controlled flying video recording system, the radio transmitter and radio receiver can be part of a radio transceiver.

In some embodiments of the remotely controlled flying video recording system, the command signals can further comprise a request from the remote transmitter to begin storing of video captured by the camera on the electronic memory, and the video controller can be further configured to, responsive to determining the speed is below the threshold speed level, cause transmission to the remote transmitter data indicating the request to begin storing of video captured by the camera has been denied.

In some embodiments of the remotely controlled flying video recording system, the remote transmitter can comprise the remote video display device.

In some embodiments of the remotely controlled flying video recording system, the one or more propulsion units can comprise at least four propulsion units, and each of the one or more propulsion units can comprise at least one motor and at least one propeller.

In some embodiments of the remotely controlled flying video recording system, the video controller can comprise a computer processor separate from second computer processor configured to perform flight control functions of the remotely controlled flying video recording system.

In some embodiments of the remotely controlled flying video recording system, the video controller can comprise a computer processor that can also be configured to perform flight control functions of the remotely controlled flying video recording system.

A remotely controlled flying video recording system in accordance with the present disclosure can comprise a remote control device having a radio transmitter configured to transmit command signals comprising at least flight control data configured to adjust operation of one or more propulsion units of a remotely controlled flying device for causing flight of the flying device, the flying device further comprising a radio receiver configured to receive the command signals from the transmitter of the remote control device, a camera configured to capture video, a radio transmitter configured to stream video captured by the camera to a remote video display device, and a speed sensor configured to detect a speed of the remotely controlled flying device, the remote control device further comprising an electronic memory controller configured to be electronically coupled to an electronic memory for storing the video captured by the camera on the electronic memory, and a video controller configured to communicate with the remotely controlled flying device to monitor the speed of the remotely controlled flying device as detected by the speed sensor, compare the speed of the remotely controlled flying device to a threshold speed level, and responsive to determining the speed is below the threshold speed level, disable storing of video captured by the camera on the electronic memory.

In some embodiments of the remotely controlled flying video recording system, the video controller can be further configured to responsive to determining the speed is below the threshold speed level, cause the radio transmitter of the remote control device to transmit to the remote video display device an indication that storing of video has been disabled.

In some embodiments of the remotely controlled flying video recording system, the video controller can be configured to enable the radio transmitter of the flying device to continue streaming video captured by the camera to the remote video display device, even if the video controller has disabled storing of video captures by the camera on the electronic memory.

In some embodiments of the remotely controlled flying video recording system, the video controller can be further configured to monitor an amount of time the speed has been below the threshold speed level, compare the amount of time the speed has been below the threshold speed level to a recording time delay, and responsive to determining the speed is below the threshold speed level, disable storing of video captured by the camera on the electronic memory only if the amount of time the speed has been below the threshold speed level exceeds the recording time delay.

In some embodiments of the remotely controlled flying video recording system, the video controller can be further configured to compare the amount of time the speed has been below the threshold speed level to a streaming time delay, the streaming time delay being greater than the recording time delay, and responsive to determining the speed is below the threshold speed level and that the amount of time the speed has been below the threshold speed level exceeds the streaming time delay, disable the radio transmitter of the flying device from streaming video captured by the camera to the remote video display device.

In some embodiments of the remotely controlled flying video recording system, the video controller can be further configured to compare the amount of time the speed has been below the threshold speed level to a streaming time delay, the streaming time delay being greater than the recording time delay, and responsive to determining the speed is below the threshold speed level and that the amount of time the speed has been below the threshold speed level exceeds the streaming time delay, cause the radio transmitter of the flying device to stream an obscured version of video captured by the camera to the remote video display device, wherein the obscured version can comprise one or more of the following: a reduced-quality version of the video captured by the camera, or a watermarked version of the video captured by the camera.

In some embodiments of the remotely controlled flying video recording system, the video controller can be further configured to analyze video captured by the camera to detect whether a human is present in the video captured by the camera, and responsive to determining the speed is below the threshold speed level, disable storing of video captured by the camera on the electronic memory only if a human is present in the video captured by the camera.

In some embodiments of the remotely controlled flying video recording system, the video controller can be further configured to communicate with an altitude sensor on the flying device to monitor the altitude of the remotely controlled flying device, compare the altitude of the remotely controlled flying device to a threshold altitude level, and responsive to determining the speed is below the threshold speed level, disable storing of video captured by the camera on the electronic memory only if the altitude of the remotely controlled flying device is below the threshold altitude level.

In some embodiments of the remotely controlled flying video recording system, the speed sensor can comprise a Global Positioning System (GPS) sensor, a pressure sensor, an optical sensor, and/or an accelerometer.

In some embodiments of the remotely controlled flying video recording system, the system can further comprise the electronic memory, the electronic memory located in the flying device, the remote control device, the display device, or a remote server.

In some embodiments of the remotely controlled flying video recording system, the remote control device can comprise the remote video display device.

In some embodiments of the remotely controlled flying video recording system, the video controller can be further configured to, responsive to determining the speed is below the threshold speed level, cause transmission to the remote video display device data indicating the request to begin storing of video captured by the camera has been denied.

Although various embodiments disclosed herein are described with reference to drones or other flying devices, the camera-related functions described herein can also be applicable in other situations. For example, it can be desirable to enable or disable a camera or certain functionality of the camera in a ground vehicle, such as a remote-controlled car. Further, it can be desirable to incorporate such automatic disabling and enabling control systems in a standalone camera that can be held by a user and/or attached to any movable object. Although various embodiments disclosed herein describe a camera and electronic storage medium for storing recordings as part of the flying device, the same or similar concepts can apply to a system where video is streaming from the flying device to a user's controller, smart phone, computing device, and/or the like and is able to be recorded by the user's device. In such a case, the systems can be configured to selectively disable viewing and/or recording of the streaming video via the user's controller, smart phone, computing device, and/or the like. The recording can comprise recording of a video and/or still pictures.

In some embodiments, a device as disclosed herein is referred to as a motion activated video camera and is configured to only enable recording when the vehicle is in motion.

### BRIEF DESCRIPTION OF THE DRAWINGS

Various embodiments will be described hereinafter with reference to the accompanying drawings. These embodiments are illustrated and described by example only, and are not intended to limit the scope of the disclosure. In the drawings, similar elements have similar reference numerals.

FIG. 1 illustrates schematically a flying camera system with improved privacy protection control mechanisms.

FIG. 2A illustrates schematically a perspective view of an example flying device with a camera.

FIG. 2B illustrates schematically a bottom view of a front body portion of the flying device of FIG. 2A.

FIGS. 3A-3E illustrate schematically example flying camera systems in accordance with the present disclosure.

FIG. 4A illustrates a flow chart of an example flying camera control mechanism in accordance with the present disclosure.

FIG. 4B illustrates a flow chart of an example flying camera control mechanism in accordance with the present disclosure.

FIG. 4C illustrates a flow chart of an example flying camera control mechanism in accordance with the present disclosure.

FIG. 4D illustrates a flow chart of an example flying camera control mechanism in accordance with the present disclosure.

FIG. 5 illustrates example control signals during operation of a flying camera system in accordance with the present disclosure.

FIG. 6A illustrates a flow chart of an example flying camera control mechanism in accordance with the present disclosure.

FIG. 6B illustrates a flow chart of an example flying camera control mechanism in accordance with the present disclosure.

FIG. 6C illustrates a flow chart of an example flying camera control mechanism in accordance with the present disclosure.

FIG. 6D illustrates a flow chart of an example flying camera control mechanism in accordance with the present disclosure.

FIG. 6E illustrates a flow chart of an example flying camera control mechanism in accordance with the present disclosure.

FIG. 6F illustrates a flow chart of an example flying camera control mechanism in accordance with the present disclosure.

FIG. 6G illustrates a flow chart of an example flying camera control mechanism in accordance with the present disclosure.

FIG. 6H illustrates a flow chart of an example flying camera control mechanism in accordance with the present disclosure.

FIG. 7 illustrates a flow chart of an example flying camera control mechanism in accordance with the present disclosure.

FIGS. 8A-8B illustrate example control signals during operation of a flying camera system in accordance with the present disclosure.

FIG. 9 illustrates schematically an embodiment of a flying device.

FIG. 10 illustrates a flow chart of example signal processing and/or operations of a flying device.

### DETAILED DESCRIPTION

Although embodiments, examples, and illustrations are disclosed below the disclosure described herein extends beyond the specifically disclosed embodiments, examples, and illustrations and includes other uses of the disclosure and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure can comprise several novel features and no single feature is solely responsible for its desirable attributes or is essential to practicing the disclosures herein described.

The disclosure herein provides systems, methods, and devices that enable a flying camera system to disable recording and/or streaming by a camera system based on one or more programmed criteria. The programmed criteria can be based at least in part on predictions of when the flying camera system is likely being used as a surveillance camera and/or in situations that can result in an invasion of privacy. The predictions can be based on movements of a flying device of the system and/or the surrounding environment. A flying camera system can result in invasion of privacy when the flying device is stationary or substantially stationary, hovering over a small area, moving at low elevation, and/or moving in a populated area with expectation of heightened privacy level. The disabling of camera functions can be complete, partial, or have different levels depending on the degree of privacy concerns and/or safety concerns of the flying device.

In some embodiments, a flying device can disable the camera when the device is stationary, is moving below a minimum speed, and/or is moving below a minimum speed over a set amount of time. The camera can be immediately enabled upon reaching and/or exceeding the minimum speed, or upon reaching and/or exceeding an enabling threshold speed, which can be different from the minimum speed. The camera can remain enabled until the device no longer satisfies the programmed criteria, at which point the camera can be disabled again.

In some embodiments, the flying camera system may only prevent certain functions and/or features of the camera from operating if the flying device does not meet the programmed criteria. In some embodiments, the flying camera system may only prevent video recording and/or pictures taking, while allowing a user to operate the flying device remotely with continued video streaming capabilities. In some embodiments, the system can obscure the streamed video, while still allowing the streaming to guide the user in remotely operating the flying device. The camera functions can be immediately enabled upon reaching and/or exceeding the minimum speed or the enabling threshold. The camera functions can remain enabled until the flying device no longer satisfies the programmed criteria, at which point the camera is disabled again. In some embodiments, the system is configured to enable the camera recording and/or streaming functions only when the flying device is in motion.

One of the benefits in disabling and/or activating the camera or certain camera functions based at least in part on motion sensing of the flying device is that it prevents the use of the flying camera as a surveillance device. For example, this can prevent a flying camera system user from hovering the flying device outside a window of a house and record a video of the interior of the house through the window, but still allow the recording to begin or resume when the user flies the device at or above a minimum speed. When the flying device is moving at or above a minimum speed, it is less likely that the camera focuses on particular person(s) and/or interior of a building for an extended period of time. Disabling and/or activating a camera or camera functions based at least in part on motion sensing of the flying device can achieve a balance between privacy concerns and flying device capabilities.

Another benefit in disabling and/or activating the camera or certain camera functions based at least in part on motion sensing is that there is little or no interruption of the camera functions when the flying camera system is used in situations with low privacy concern and/or for legitimate purposes. A substantial portion of the flying camera system use involving the recording of video occurs while the flying device is in motion and/or passing through areas without lingering. For example, flying camera systems can be used in recording athletes running a cross-country race, skiing down a mountain, a mountain biker riding a trail, a jet ski or surfer jumping on waves, animals in the wilderness, sceneries, and the like. More examples include the recording of a home or property related to real estate sales, surveys of a plot of land, aerial photography, search and rescue, highway patrol, package delivery, and just recording for the novelty of having a camera off the ground. There are also legitimate uses of the camera functions that require an airborne flying device that remain stationary or substantially stationary. However, the privacy concerns may outweigh the advantages of a fully functional and/or unlocked camera in certain flying camera system types and/or applications.

In some embodiments, the disabling, enabling, re-disabling, and re-enabling of the camera or camera functions is configured to be quick and seamless such that the change can take place in real time (including signal processing time) or substantially in real time without the user losing control of the flying device and/or requiring the user to take his or her eyes off of the flying device and/or video display device. The flying camera system can output a notification signal to the user that the camera or camera functions have been disabled and/or enabled. The signal can be audible, visual, haptic, or any combinations thereof.

Although various embodiments disclosed herein are described with respect to a flying device having two modes comprising a camera with a disabled state and an enabled state, various other embodiments can have two or more modes that cause the disabling of other features based on different programmed criteria. For example, at a certain programmed speed and/or at a certain programmed speed for a predetermined amount of time, the system can prevent all use of the camera. As the flying device increases speed, other features can be enabled individually or all together, such that all camera functions are eventually available and enabled when the flying device meets the programmed criteria.

A flying camera system as disclosed herein can determine the speed of the flying device in various ways. For example, the flying camera system can determine a present speed of the flying device using signals indicative of speed from the flying device, such as from a GPS unit, an optical sensor that is positioned to view surrounding terrain, analysis of the video feed from the camera, an air pressure-based sensor, an accelerometer, other sensors, or a combination of any such sensors. Alternatively and/or additionally, the speed of the flying device can be estimated based on inputs from the user on a remote control device configured to control various aspects of the flying device, such as the position of joysticks, current outputs to the propellers, flight surfaces, and/or the like. For example, the remote control device and/or the flying device can be programmed to estimate the speed of the flying device based on the manner with which the propellers or flight surfaces are being controlled to operate. The system can be configured to utilize this estimate for determining the speed of the flying device. In some embodiments, the system can take into account the wind speed and/or other corrections when calculating the speed of the flying device. The system can combine one or more speed signal outputs from various sources to improve accuracy of the calculation of the speed of the flying device.

Various threshold levels can be used in determining when to disable and/or enable recording and/or streaming by the camera. The threshold levels can be pre-programmed and/or adjustable based on user inputs, for example, based on the external environment such as the wind speed, location, or others. In some embodiments, a threshold level of 5 mph or 3 mph can be used. In other embodiments, the threshold speed can be different, such as, one mile-per-hour, 2 miles per hour, 4 mph, 6 mph, 7 miles per hour, 8 mph, 9 mph, 10 miles per hour, or the like.

In some embodiments, timers and/or different thresholds are used for disabling recording and/or streaming, and for enabling recording and/or streaming. For example, the system can be configured to enable recording and/or streaming once the flying device reaches or exceeds a threshold speed, such as 5 miles per hour. When the device decelerates to below that speed, however, the system can be configured to wait until the system drops below a disabling threshold, which can be a lower speed, such as one, two, three, or 4 mph, and/or the system can be configured to wait a predetermined amount of time below a threshold speed before disabling recording and/or streaming. When a flying device temporarily hovers in place or moves at a relatively slow speed, before speeding back up above a threshold speed, the chances of an invasion of privacy are likely lower than in a case where the flying device is hovering or flying at a low speed for an extended period of time. Accordingly, in some embodiments, the system is configured to, after dropping below a threshold speed, disable recording and/or streaming after a predetermined amount of time has lapsed, such as five, 10, 15, 20, 25, 30, 35, 40, 45, 50, 55, 60 seconds, or others. These configurations can be helpful to avoid disrupting the recording in temporary instances of slow speed or stationary flight and/or can promote smooth transitions between enabling and disabling of the camera functions.

In some embodiments, the system can be configured to take into account more than the speed of the flying device when deciding whether to enable or disable certain camera functions. For example, the system can be configured to take into account acceleration of the flying device. For example, if the flying device speed is below a threshold level, but the acceleration of the device is relatively high, that can be an indicator that the device will likely exceed the threshold speed soon, and thus the system can continue or resume recording and streaming. As another example, if the deceleration is relatively high when the flying device is slowing down, this may not be intended by the user of the flying device and thus can be an indicator of a situation less likely to be an invasion of privacy. The system can continue allowing recording even when the flying device is below a threshold speed at least until the magnitude of deceleration decreases, which can indicate the user is intending to have the flying device hover or remain substantially stationary.

In some embodiments, the system can be configured to take into account other parameters and/or factors, such as the altitude of the flying device, the geographical location of the flying device, and/or whether human presence can be detected in the video captured by the camera. The flying camera system is less likely to invade any privacy when the flying device is above a certain altitude, at geographical locations where human presence is unlikely and/or public places where people do not expect to have heightened levels of privacy, such as at 10,000 feet elevation, in a park, football stadium, shopping mall.

The video recording can happen on the remote control device (such as a game console, smartphone, or tablet) instead of on a memory card of the flying device. In some embodiments, the flying device can transmit a signal to the remote control device that causes disabling and/or enabling of recording and/or streaming on the remote control device. Alternatively, in some embodiments, the flying device transmits its speed to the remote control device, and the hardware and/or software controller on the remote control device decides whether or not recording and/or streaming is available.

Various embodiments disclosed herein are described with respect to a quadcopter and a remote control unit can be configured for operation by a user to control the flight of the quadcopter. In some embodiments, the quadcopter comprises four flight control channels, namely, throttle, pitch, yaw, and roll.

The techniques disclosed herein can be utilized with any cameras mounted on remotely controlled flying device (for example, airplane, drone, helicopter, hexacopter, blimp, and/or the like), ground vehicle (for example, car, truck, and/or the like that are remotely and/or directly controlled by a user), boat, a user, or any moving object. The systems and methods disclosed herein can also be used with both toys and professional level flying devices or other remotely controlled devices, such as, for example, drones used in professional photography, package delivery, military training, competitive racing, and/or the like.

### System Overview

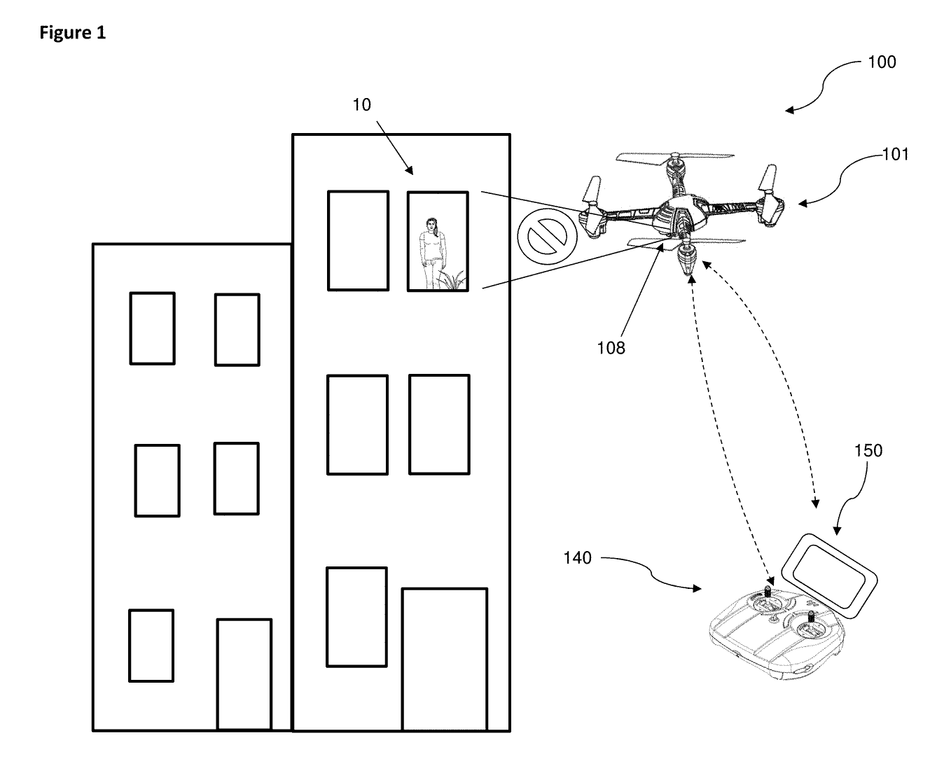

FIG. 1 illustrates schematically an example flying camera system 100 with camera functions. The system 100 can comprise a flying device 101 with at least one camera 108. The camera 108 can be built-in or separately installed onto the flying device 101. The flying device 101 can be in communication with a remote control device 140. A user can use the remote control device 140 to remotely control and/or operate the flying device 101, such as by controlling motor(s) of the flying device 101. The camera 108 can capture a video and send data of the captured video to a display device 150. The display device 150 can be coupled to the remote control device 140 or a standalone device. The flying camera system 100 can record the captured video in an electronic memory, which can be loaded in the flying device, 101, the remote control device 140, the display device 150, or on a remote server. The flying camera system 100 can also have one or more processors for driving the motor(s) of the flying device, providing instructions on whether to enable or disable camera functions, such as streaming and recording, and/or other functionality of the system. The processors can be located in the flying device 100, the remote control device 140, and/or the display device 150. As shown in FIG. 1, when the system 100 determines that the camera 108 is capturing a video that can result in privacy invasion, such as when the flying device 101 is hovering outside a window 10, the processors can disable storing of video on the electronic memory, obscure streaming of the video on the display device 150, and/or disable the streaming.

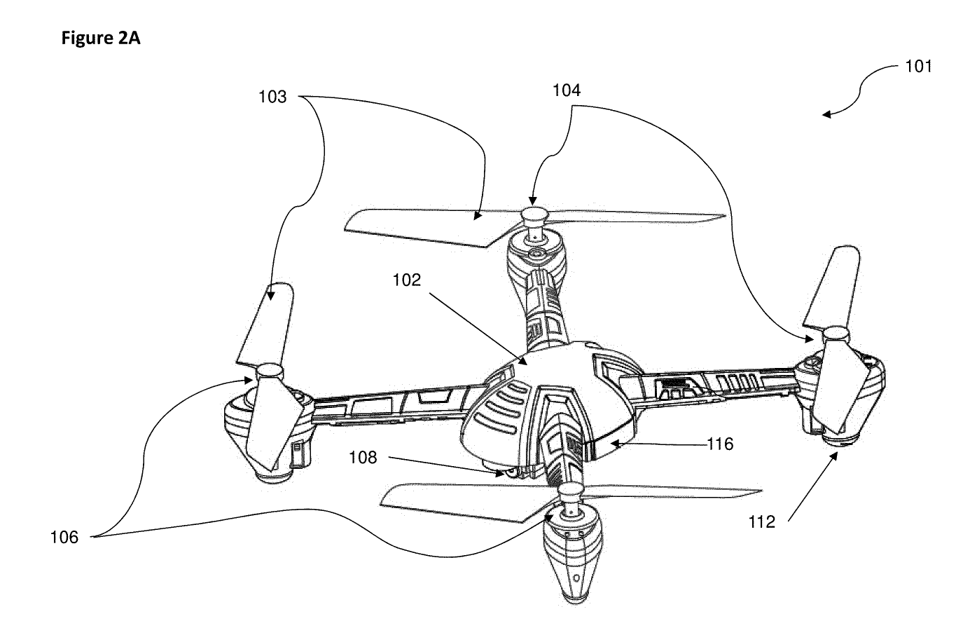

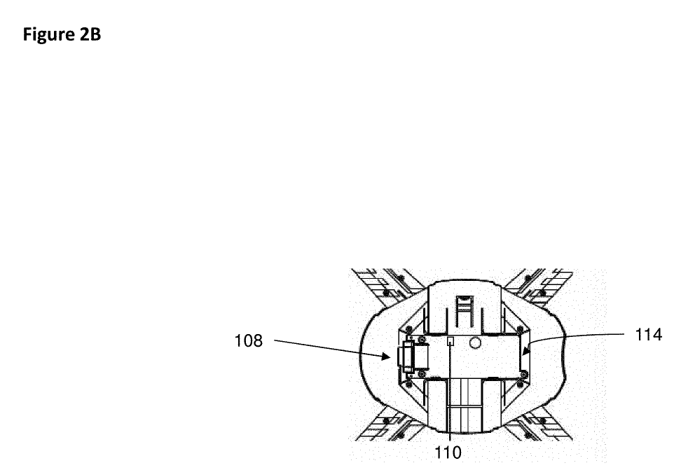

FIGS. 2A and 2B illustrate an embodiment of a remotely controlled flying device 101 that can be wirelessly controlled and can be configured to operate using the camera disabling/enabling control mechanisms disclosed herein. In the illustrated embodiment, four independently controllable motors 104 and 106 are coupled to a flying device body 102. In some embodiments, the flying device can include other numbers of motors. The motors 104 and 106 can operate to fly the flying device 101 in the air.

The flying device 101 comprises a controller that converts flight control data (for example, throttle, pitch, yaw, roll, and/or the like) into motor control signals that operate the motors 104 and 106 to implement the desired effect of the flight control data. For example, a flight control input indicating that throttle should be increased can result in the speed of all motors 104 and 106 being increased. The motors 104 and 106 are each connected to one or more rotor blades 103 that can spin to provide lift for the flying device 101 to be airborne. A flight control input indicating that the flying device body 102 should pitch forward or perform forward flight can result in, for example, the rear motors 104 having their speed increased relative to the front motors 106.

The flying device 101 can include one or more landing gears 112 to enable the flying device 101 to land on various surface-types. In some embodiments, the flying device can have a safety cage to protect the rotor blades, the flying device body, and/or any other part of the flying device from damage caused by collisions with another object (for example, floor, tree, building, or the like).

The flying device 101 includes one or more camera modules 108 to take pictures, record and/or stream video content. The camera module 108 can be located anywhere on the flying device 101. In the illustrated embodiment, the camera module 108 is installed on a bottom side of the body 102. The flying device 101 can comprise a battery module 116 to power the flying device 101. The flying device 101 can include a memory card slot 114 for the insertion of a memory card. The memory card can be used to record pictures or video from the camera module 108, and/or record additional statistics such as flight speed, battery level, servo motor position, and/or other data available through sensors and internal components of the flying device 101. The flying device 101 can include one or more status indicators 110, such as LED emitters.

Although FIGS. 1 and 2A illustrate a flying device 101 having four flight control channels, namely throttle, pitch, roll, and yaw, various other flight control channel configurations and/or naming conventions can be utilized without departing from the techniques disclosed herein. For example, in some embodiments, the throttle flight control channel can be referred to as an altitude channel, the pitch channel can be referred to as a forward and backward movement flight control channel, the roll flight control channel can be referred to as a bank flight control channel, and/or the yaw flight control channel can be referred to as a turn or spin flight control channel.

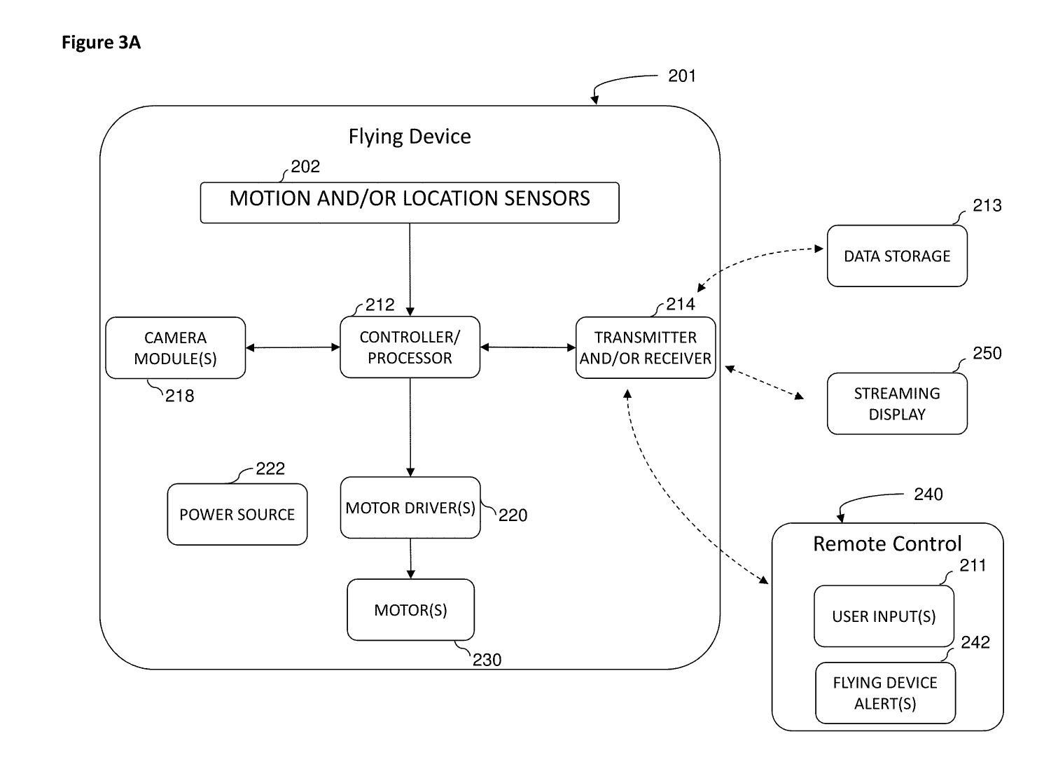

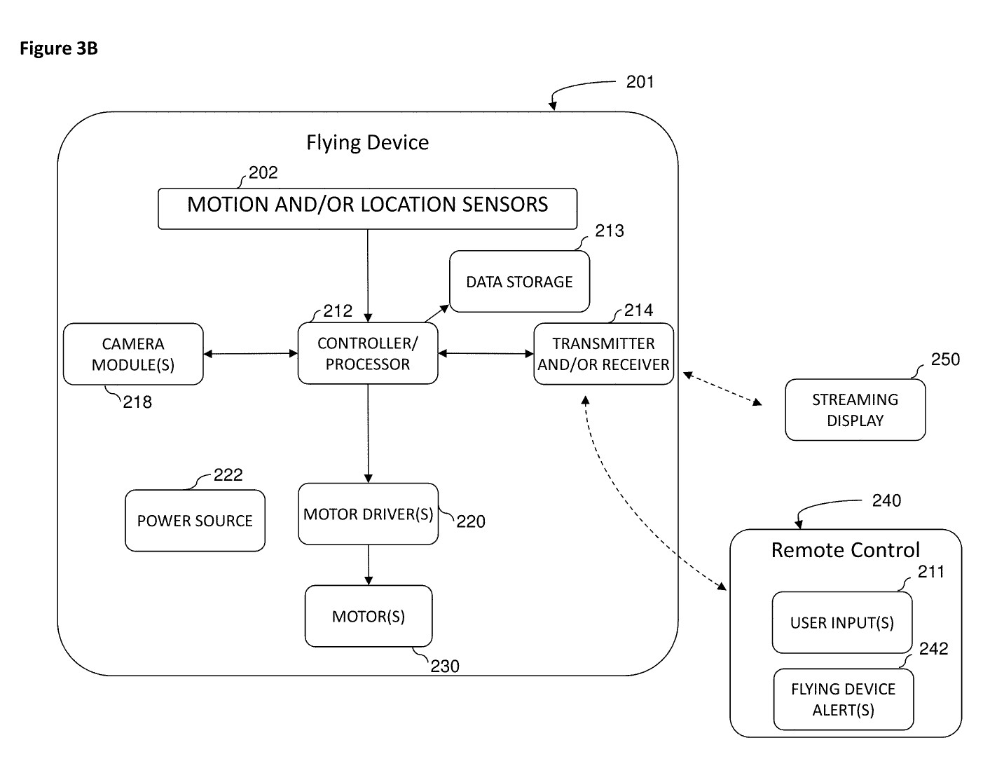

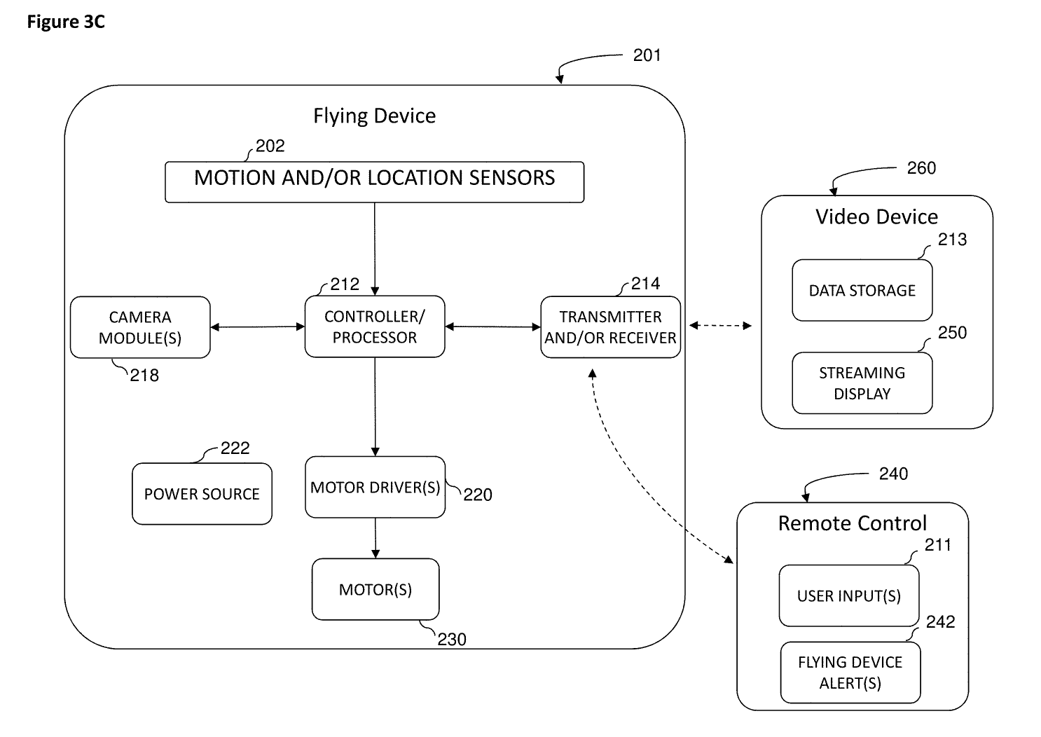

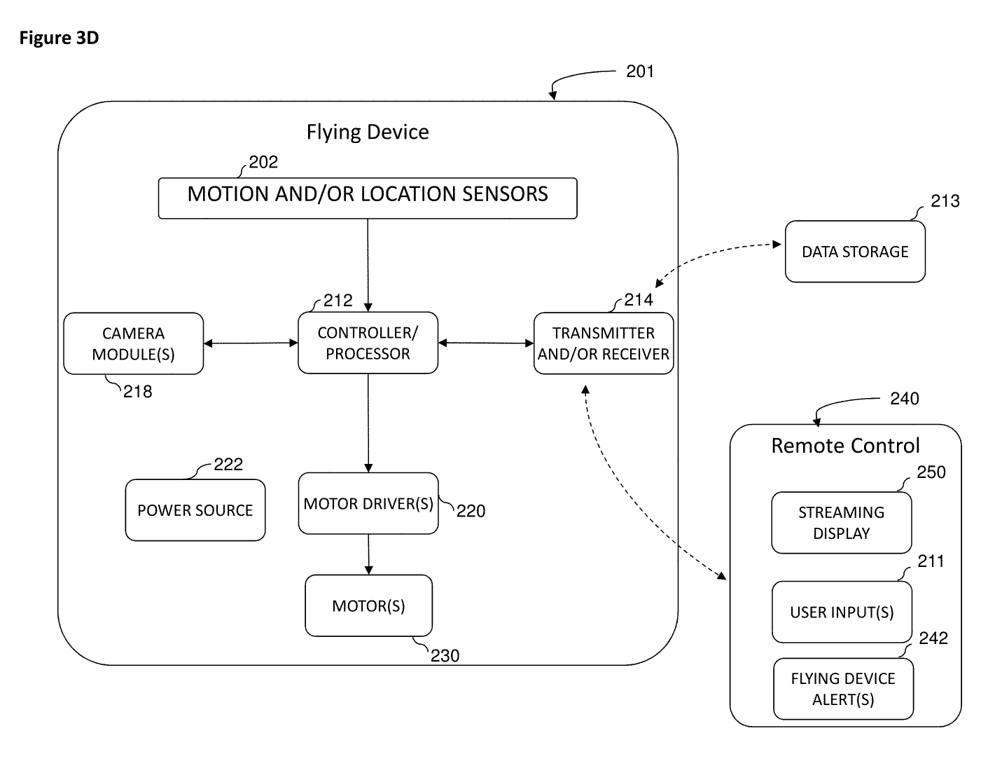

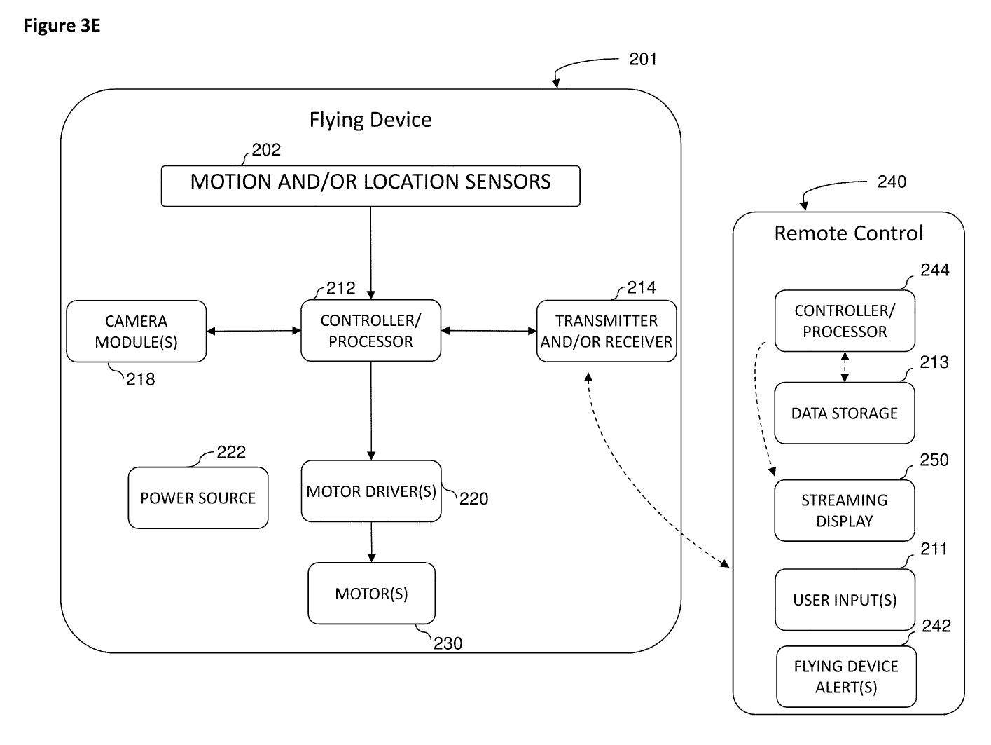

Various embodiments of the flying camera system will now be described with reference to FIGS. 3A-3E. The system can comprise a flying device 201 in electrical communication with a remote control 240 and other components. As shown in FIG. 3A, the flying device 201 comprises one or more hardware and/or software controllers or processors 212 in electrical communication with one or more motion and/or location sensors 202, transmitter and/or receiver (or a transceiver) 214, camera module(s) 218, and motor driver(s) 220 coupled to motor(s) 230. The flying device 201 can further include a power source 222, such as a battery module.

The sensors 202 in the flying device 201 can comprise at least one or more of a gyroscope, accelerometer, magnetometer, GPS, an optical sensor, thermometer, barometer, altimeter, and/or the like. The flying device 201 can use one or more of the sensors 202 to measure a speed of the flying device 201.

The transmitter and/or receiver 214 is configured to transmit and receive signals between the flying device 201, the remote control device 250, a remote video display device 250, and/or a data storage module 213, which can be hosted in a remote server. The signals can be sent via wireless radio, infrared wireless, wired, and/or the like. The received signal at the transmitter and/or receiver 214 is sent to the controller or processor 212 for processing and executing actions based on the received signal. In response to the processed signals, the controller 212 can send commands to the appropriate other components of the flying device 201. For example, the controller 212 can perform, among other things, conversion of flight control commands from the remote control device 240 into motor control commands to implement the desired flight control operations. The signals transmitted from the transmitter and/or receiver 214 can include the speed of the flying device 201 and other flying device parameters. The controller 212 can also be used to perform other control functions of the flying device 201. For example, the controller 212 can send commands to enable or disable one or more camera functions based on the speed and/or other flying device parameters, and/or grant or deny commands to enable or disable camera function(s).

The signals received at the remote video display device 250 can include streaming data of the video captured by the camera module 218 and also optionally commands to start or stop video streaming. The display device 250 can display the streamed video, which can aid the user in operating the flying device 201, which can be out of plain sight of the user, and/or allow the user to view content of the video from a vantage point otherwise not likely available to the user. The video display device 250 can have a display screen and/or can project the streamed video image.

The signals received at the remote control device 240 can include signals indicative of flying device parameters and/or notification or alert(s) to the user that certain camera functionality has been enabled and/or disabled. The remote control device 240 can allow the flight control command to be adjusted responsive to the flying device parameters, automatically or by the user. The remote control device 240 can output the flying device alert(s) 242, such as alerts that are audible, visual, haptic, or any combinations thereof. The system can also allow for users input(s) 211 to control various aspects or components of the flying device 201. For example, there can be one or more buttons, switches, microphones (for example, for auditory commands to be received by the user), or the like on the remote control device 240.

The signals received at the data storage module 213 can include video data captured by the camera module 218 and/or commands from the controller 212 to store or not store the video.

The flying camera systems in FIGS. 3B-3E have the same or substantially the same features as the flying camera system in FIG. 3A, except as described below. Accordingly, features of the flying camera systems in FIGS. 3A-3E can be incorporated into one another. The components of the flying camera systems in FIGS. 3A-3E can also be combined in other configurations without departing from the technology disclosed herein.

In FIG. 3B, the data storage module 213 can be located in the flying device 201. The data storage module 213 can also comprise read-only memory for the controller 212 to execute previously programmed functions (for example, to turn the LED light on when the flying device is powered on). The data storage module 213 can additionally or alternatively comprise writeable memory to store various programmed functions, data received from the various sensors 202, and/or the like. The data storage module 213 need not contain both types of memory, and can be two or more separate elements optionally implemented. For example, the read-only memory can be incorporated and no other writable memory may be provided. Alternatively, there may be no electronic memory installed and any instructions may come directly from a controller. Alternatively, there can be read-only memory installed in the flying device 201 and the user can install a physical memory card or chip to store additional information. The data or information that can be stored in the data storage module 213 can, for example, originate from the component that created the information and go through processing prior to being written to the writable memory.

In FIG. 3C, the data storage module 213 and the display device 250 can be incorporated in a single video device 260. The video device 260 can be, for example, a smart phone, tablet, laptop, or others.

In FIG. 3D, the video display device 250 can be coupled to the remote control device 240. In some embodiments, the video display device 250 can have a retracted configuration and an extended configuration. The video display device 250 can be in the retracted configuration during non-use to make the remote control device 240 more compact and be in the extended configuration during use to allow easy viewing of a display screen. The display device 250 can also have no screen but projects the video image, such as holographically.

In FIG. 3E, the remote control device 240 can comprise the data storage module 213, the display device 250, the user input(s) 211, and the flying device alert(s) 242. The remote control device 240 can further include a remote control controller and/or processor 244. The remote control processor 244 can receive speed and/or other flying device parameters from the flying device controller 212. The remote control processor 244 can be in communication with the data storage module 213 and/or the display device 250, and can output commands to enable or disable video recording and/or streaming in response to the speed and/or other flying device parameters.

In some embodiments, the separate components of FIGS. 3A-3E can be combined into fewer components to achieve the same purpose. For example, the gyroscope, accelerometer, magnetometer can be combined into a single inertial motion sensor (IMS), such as a 9-axis IMS.

### Certain Embodiments of Flying Camera Control Mechanism

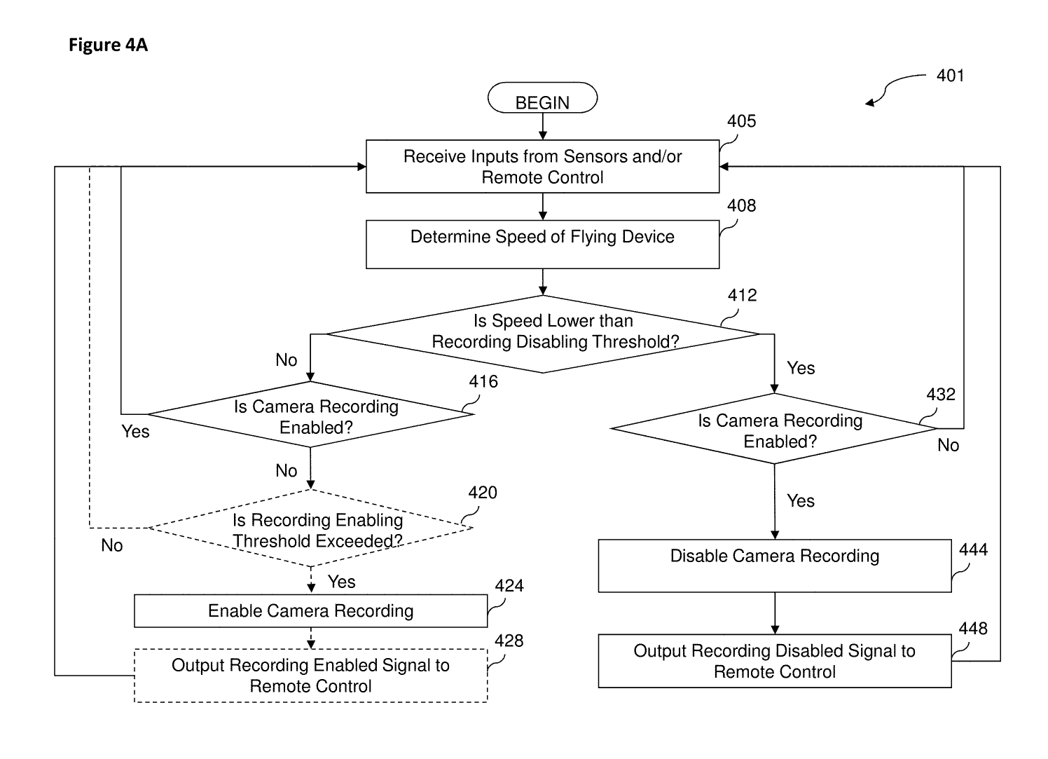

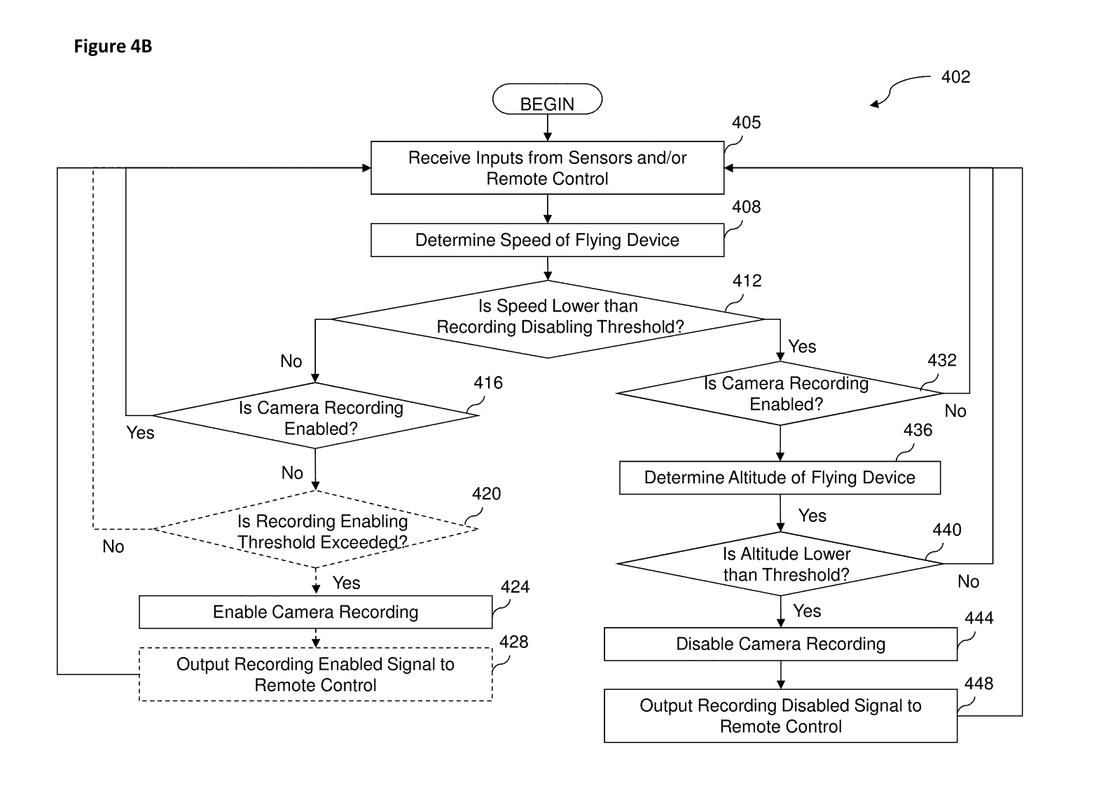

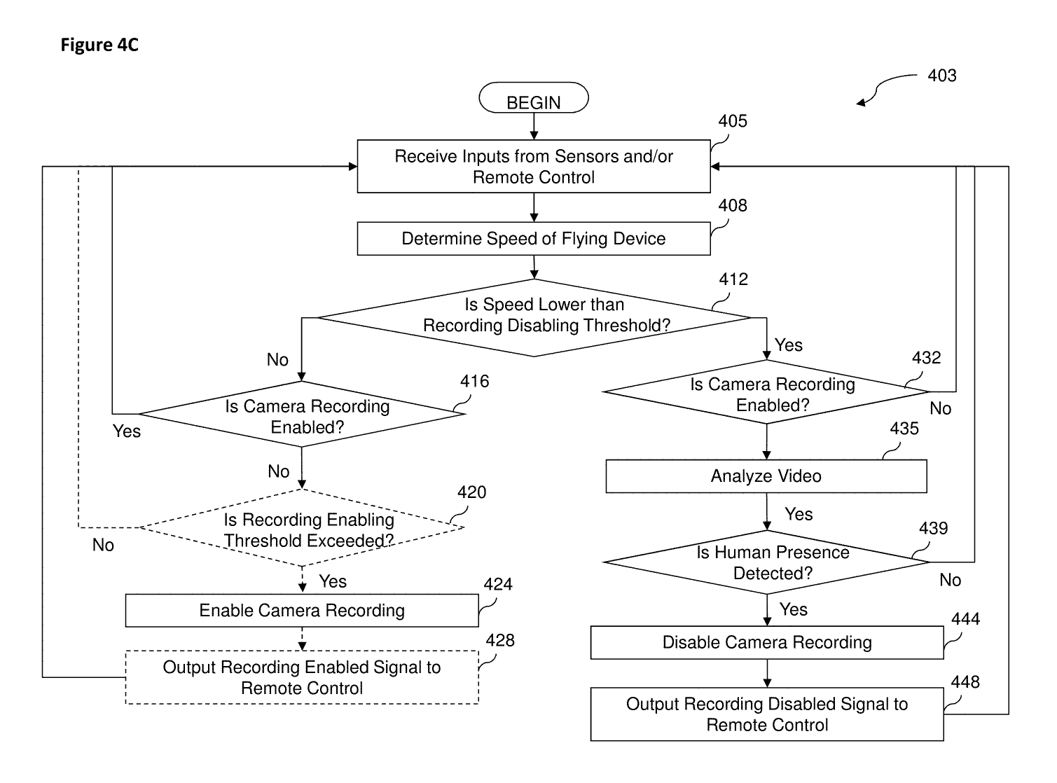

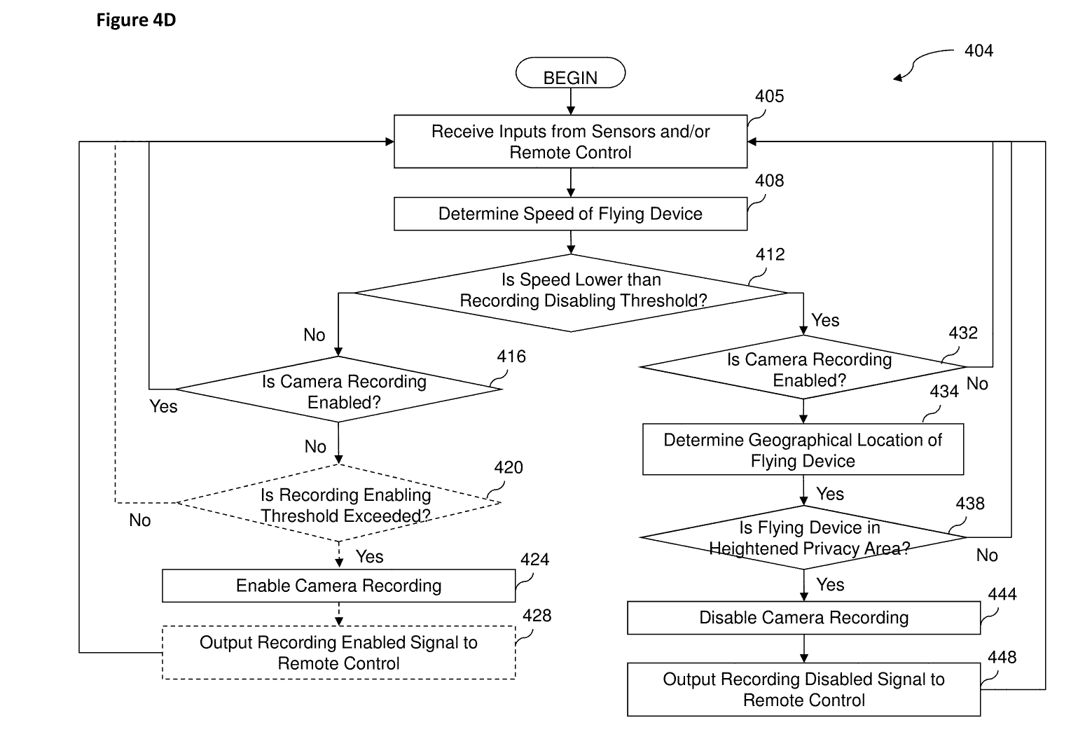

FIGS. 4A-4D illustrate example remote camera control mechanisms 401, 402, 403, 404. The methods and systems described herein can produce the same results with software programming, mechanical control, and/or through circuitry.

As shown in FIGS. 4A-4D, the mechanisms 401, 402, 403, 404 can begin when the flying device and/or the remote control device powers on. At block 405 the controller, which can be the flying device controller or the remote control controller, receives inputs from the sensors on the flying device and/or from the remote control device. The sensors can include the motion and/or location sensors described herein, such as the GPS unit, optical sensor that is positioned to view surrounding terrain, analysis of the video feed from the camera, air pressure-based sensor, accelerometer, or a combination of any such sensors. The inputs from the remote control device can include, for example, the position of joysticks, current outputs to the propellers, flight surfaces, and/or the like.

At block 408, the controller can determine the speed of the flying device. The speed can be determined from any one or a combination of the inputs in block 405. For example, the controller can estimate the speed of the flying device based on the manner with which the propellers or flight surfaces are being controlled to operate. In some embodiments, the system can take into account the wind speed and/or other corrections when calculating the speed of the flying device. The system can combine one or more speed determinations from various sources to improve accuracy of the calculation of the flying device speed, for example, by taking an average or weighted average of the one or more speed determinations, or using one of the speed signals as the primary source, such as the GPS reading, and comparing the primary source reading with the other speed determinations to cross-check the primary source reading.

In some embodiments, the flying device controller determines the speed of the flying device in blocks 405 and 408 and transmits the speed determination to the remote control controller, which can implement the rest of the mechanisms 401, 402, 403, 404.

At decision block 412, the controller can determine if the speed of the flying device is lower than a recording disabling threshold. The recording disabling threshold can be between about 0 mph to about 10 mph, or about 3 mph to about 7 mph, or about 5 mph.

If the speed of the flying device is at or greater the recording disabling threshold, at decision block 416, the controller can determine if the camera recording function is enabled. If the camera is already recording, the controller can loop back to block 405 to restart the mechanism 401, 402, 403, 404. If the camera recording function has been disabled, at block 424, the controller can output commands to enable camera recording.

In some embodiments, the controller can optionally determine, at decision block 420, if the speed of the flying device exceeds a recording enabling threshold, before advancing to the block 424. The recording enabling threshold can be the same or different, such as higher, from the recording disabling threshold. The recording enabling threshold can be about 0 mph to about 10 mph, or about 4 mph to about 8 mph, or about 6 mph. Having the recording enabling threshold being higher than the recording disabling threshold can reduce and/or prevent transitioning between enabling and disabling of the recording function due to small fluctuations in the flying device speed.

If the recording enabling threshold is not exceeded, the controller can loop back to block 405 to restart the mechanism 401, 402, 403, 404. If the recording enabling threshold is exceeded, the controller can enable the recording function at the block 424. The controller can optionally output a notification signal to the remote control device at block 428 that the recording function has been enabled.

If the flying device speed is lower than the recording disabling threshold, at decision block 432, the controller also determines if the camera recording function is enabled. If the camera recording function has already been disabled, the controller can loop back to block 405 to restart the mechanism 401, 402, 403, 404.

As shown in FIG. 4A, if the camera is still recording, at block 444, the controller can output commands to disable camera recording, such as by disabling storing of video captured by the camera module on the data storage module or electronic memory, denying requests to store the captured video on the electronic memory, or by disrupting communication with the electronic memory. At block 448, the controller can also output a notification signal to the remote control device that video recording has been disabled.

The controller can then loop back to the block 405 to restart the mechanism 401, 402, 403. The mechanism 401, 402, 403, 404 can end when the flying camera system powers off and/or when the mechanism 401, 402, 403, 404 is disabled.

As show in FIG. 4B, before block 444, the controller can also determine an altitude of the flying device at block 436 from the inputs received in block 405. At decision block 440, the controller can determine if the altitude of the flying device is lower than an altitude threshold. The altitude threshold can be an elevation above which there is low probability of having human presence and/or privacy concerns, such as about 100 feet, or about 500 feet, or about 1,000 feet, or about 5,000 feet, or about 10,000 feet.

If the altitude of the flying device is at or above the altitude threshold, the controller can loop back to block 405 to restart the mechanism 401, 402, 403, 404, as it is unlikely or at least less likely that video recording by the flying camera system at that elevation can result in privacy invasion. If the attitude of the flying device is lower than the altitude threshold, the controller can advance to block 444.

As show in FIG. 4C, before block 444, the controller can also analyze the video captured by the camera module at block 435. At decision block 439, the controller can determine if human presence is detected from the video, using known facial recognition and/or other human presence detection techniques.

If the controller does not detect human presence from the video, the controller can loop back to block 405 to restart the mechanism 401, 402, 403, 404, as it is unlikely or at least less likely that video recording by the flying camera system can result in privacy invasion. If the controller detects human presence from the video, the controller can advance to block 444.

As show in FIG. 4D, before block 444, the controller can also determine the geographical location of the flying device at block 434, for example, using the GPS unit. At decision block 438, the controller can determine if the flying device is in an area where people expect heightened privacy levels, such as at home or inside an office building.

If the controller is not in such an area, for example, if the controller is in a public place like the national parks, desert, and the like, the controller can loop back to block 405 to restart the mechanism 401, 402, 403, 404, as it is unlikely or at least less likely that video recording at that location can result in privacy invasion. If the controller is in such an area, for example, in a residential neighborhood, the controller can advance to block 444.

In some embodiments, the controller can implement two or more of blocks 436, 440 of FIG. 4B, blocks 435, 439 of FIG. 4C, and/or blocks 434, 438 of FIG. 4D. The controller can advance to block 444 under any one or combination of: the flying device being below the altitude threshold, the controller detecting human presence in the video captured by the camera, and/or the flying device being in an area where people expect heightened privacy levels.

When implementing any of the mechanisms 401, 402, 403, 404 in FIG. 4A-4D, the controller can be configured to enable the transmitter to continue streaming the video captured by the camera module to the remote video display device, even if the controller has disabled the video recording function. The continued streaming of video can allow the user to continue operating the flying device in a safe manner and/or avoid collisions of the flying device with obstacles.

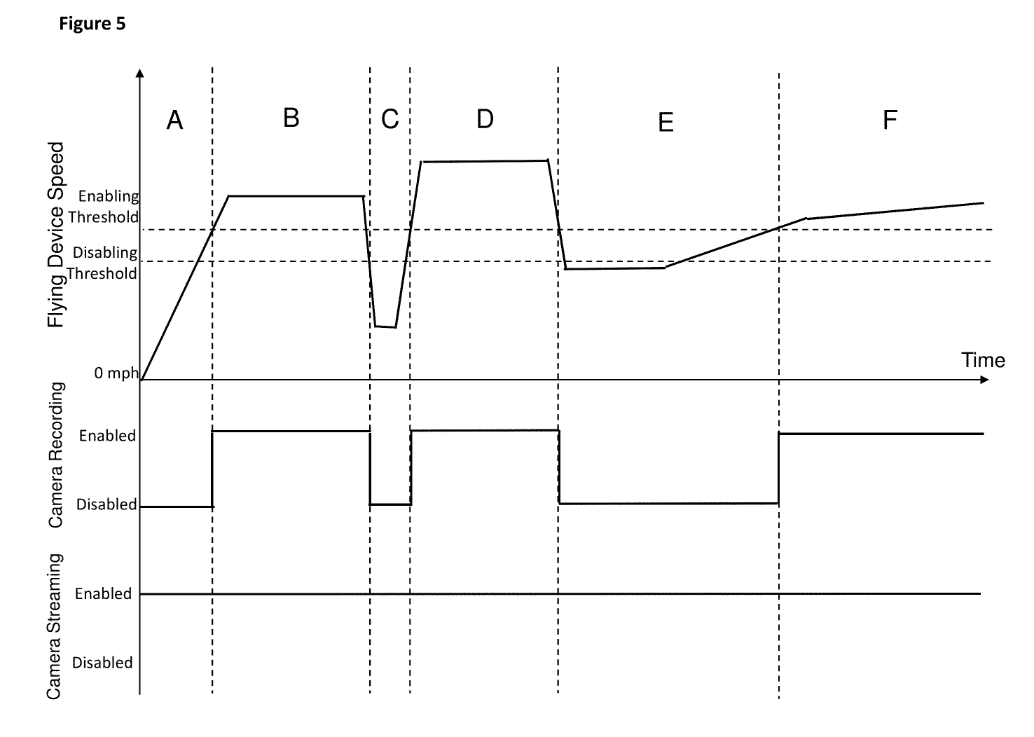

FIG. 5 illustrates various simplified control signals when implementing any of the camera control mechanisms 401, 402, 403, 404 in FIGS. 4A-4D. In time period A, the flying device is accelerating from a substantially resting or stationary position to the recording disabling threshold and the recording enabling threshold. The camera recording is not enabled because the speed is below the recording enabling threshold. In some embodiments, the camera recording function can be enabled upon powering on of the flying device. In time periods B, D, and F, the camera recording function is enabled because the flying device speed is above the recording enabling threshold. In time periods C and E, the camera recording function is disabled because the flying device speed is below the recording disabling threshold. As described above, the camera streaming function can be enabled and/or uninterrupted even if the camera recording function has been disabled in time periods A, C, and E.

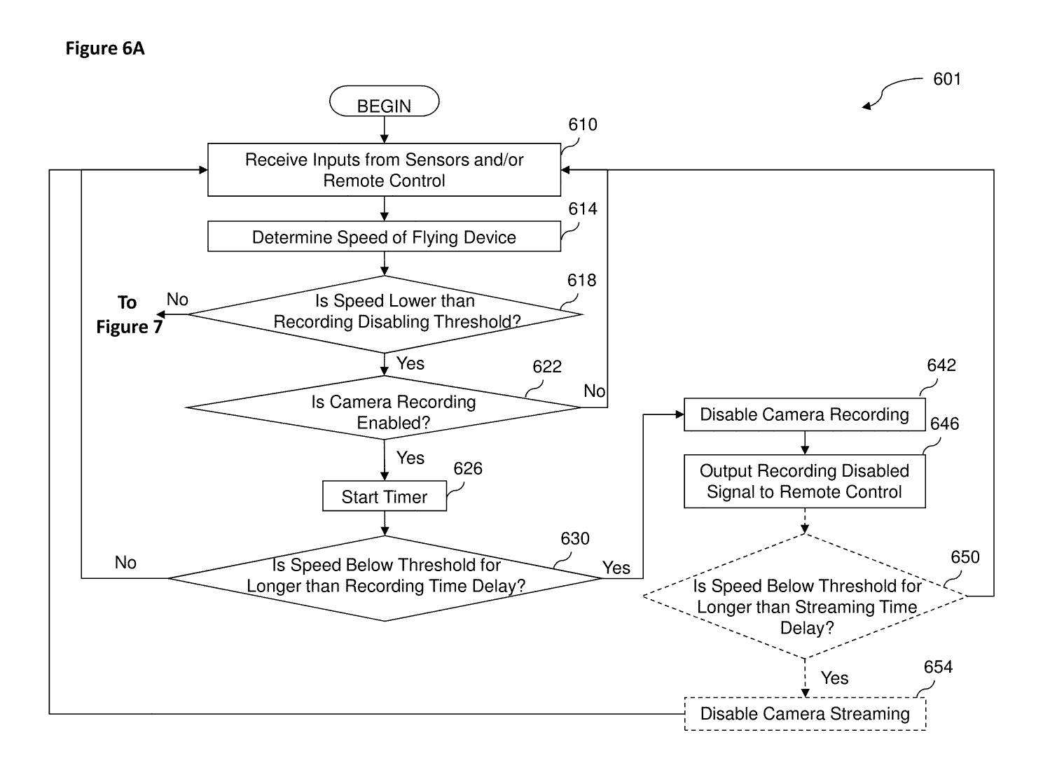

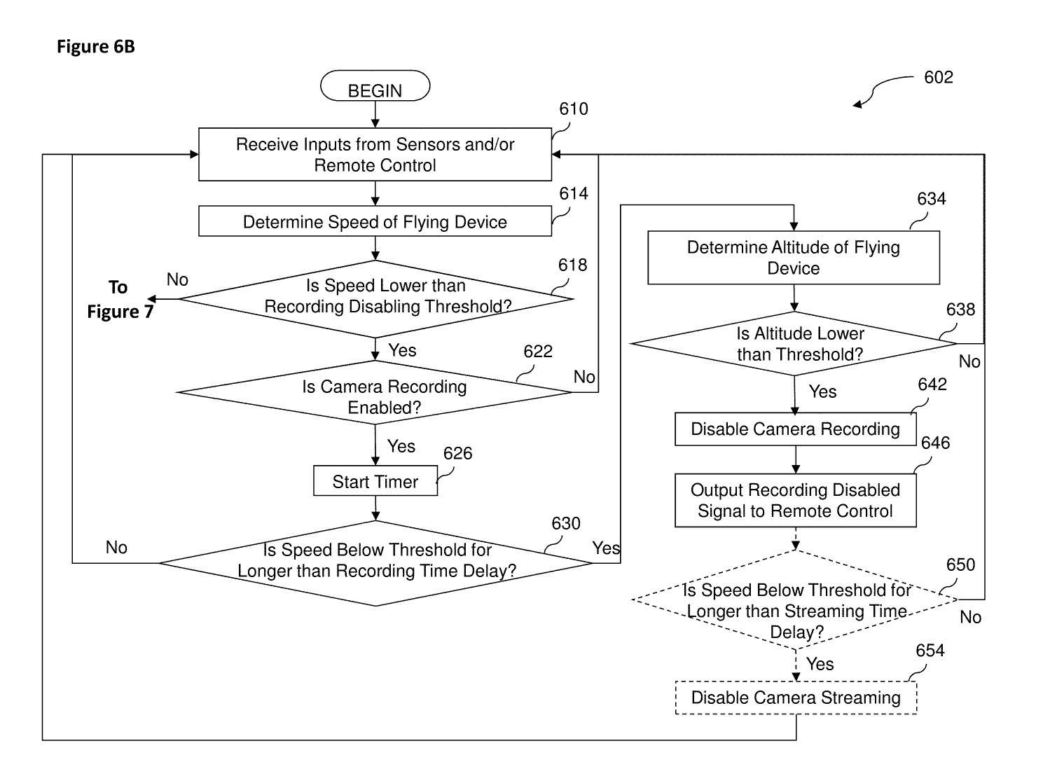

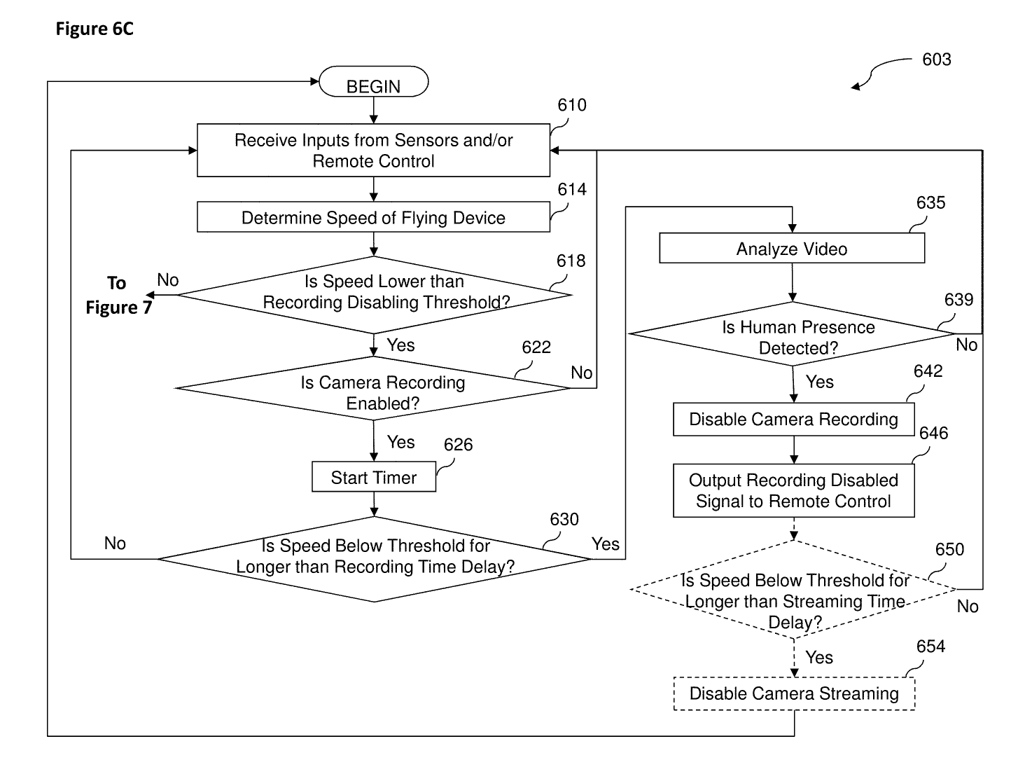

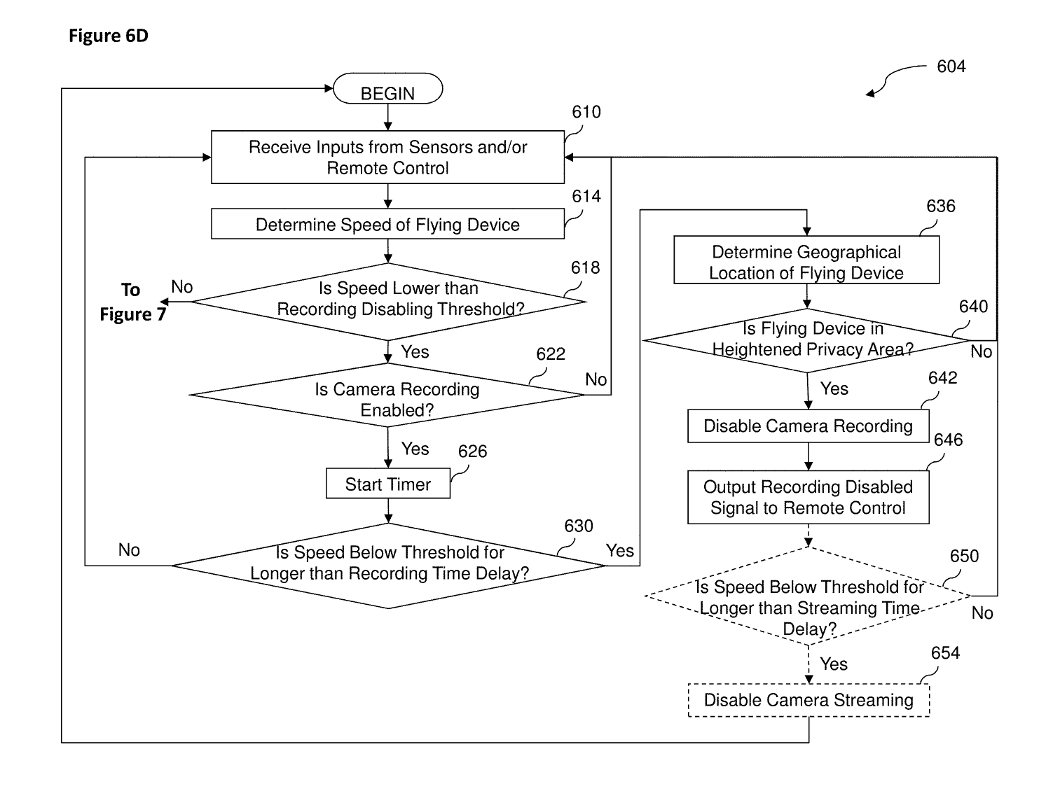

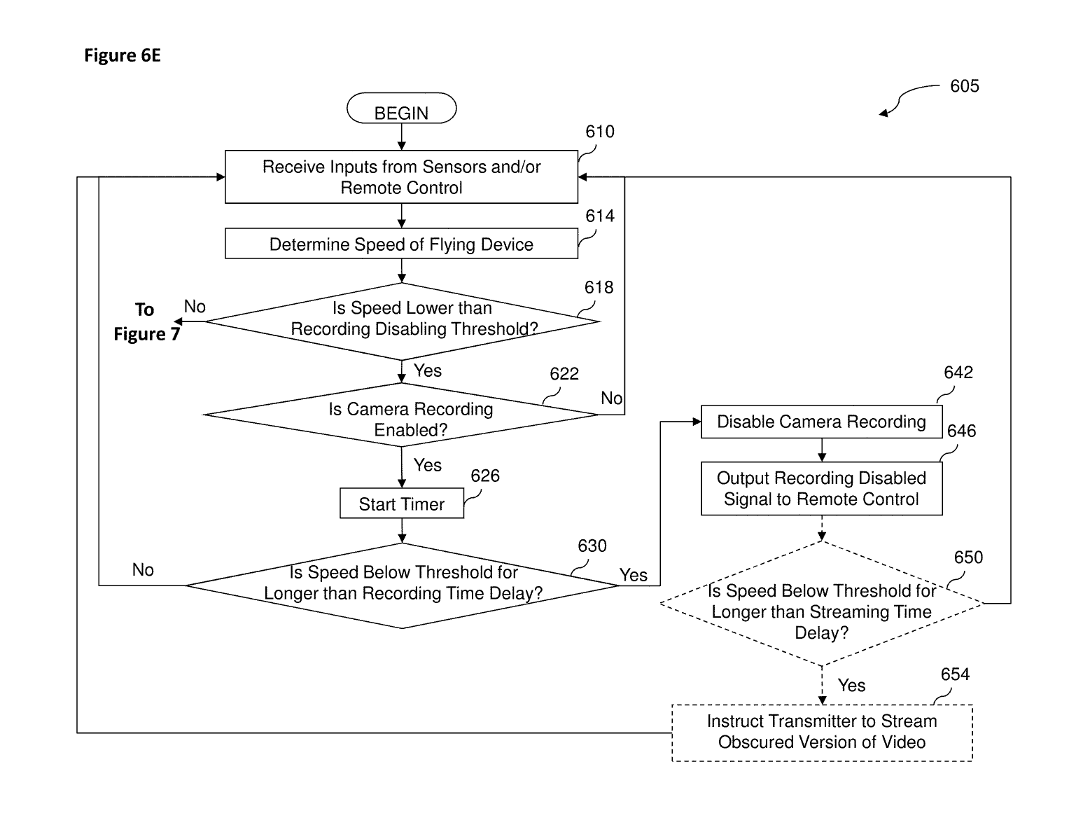

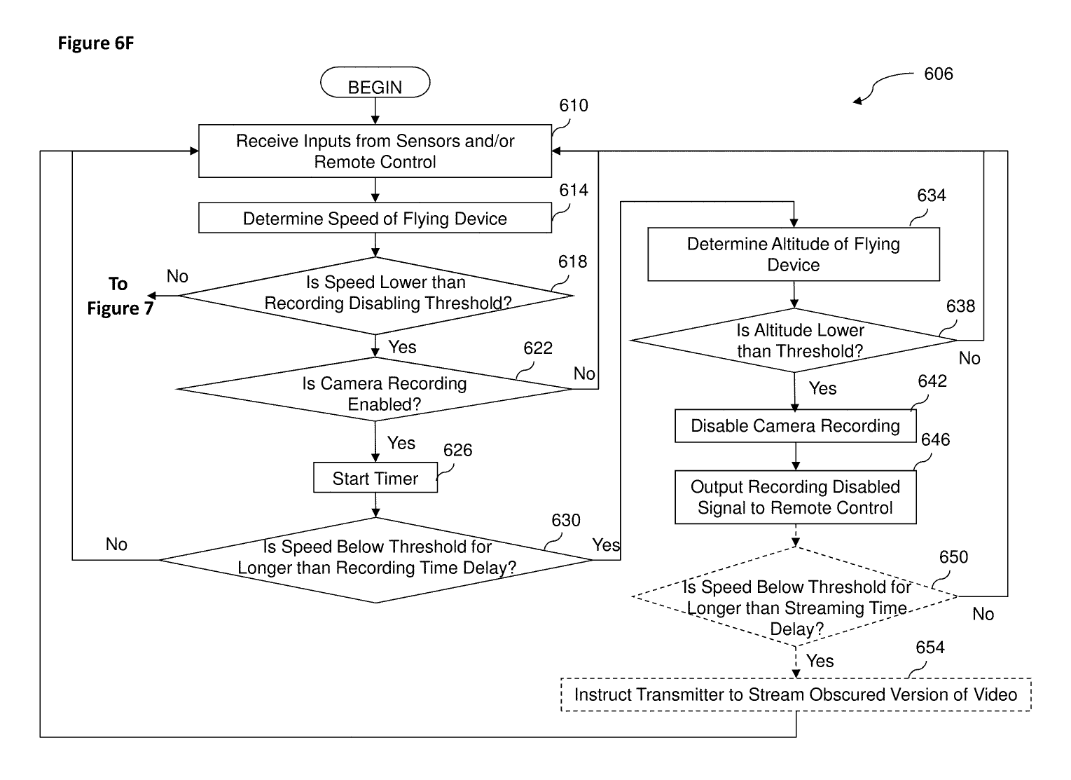

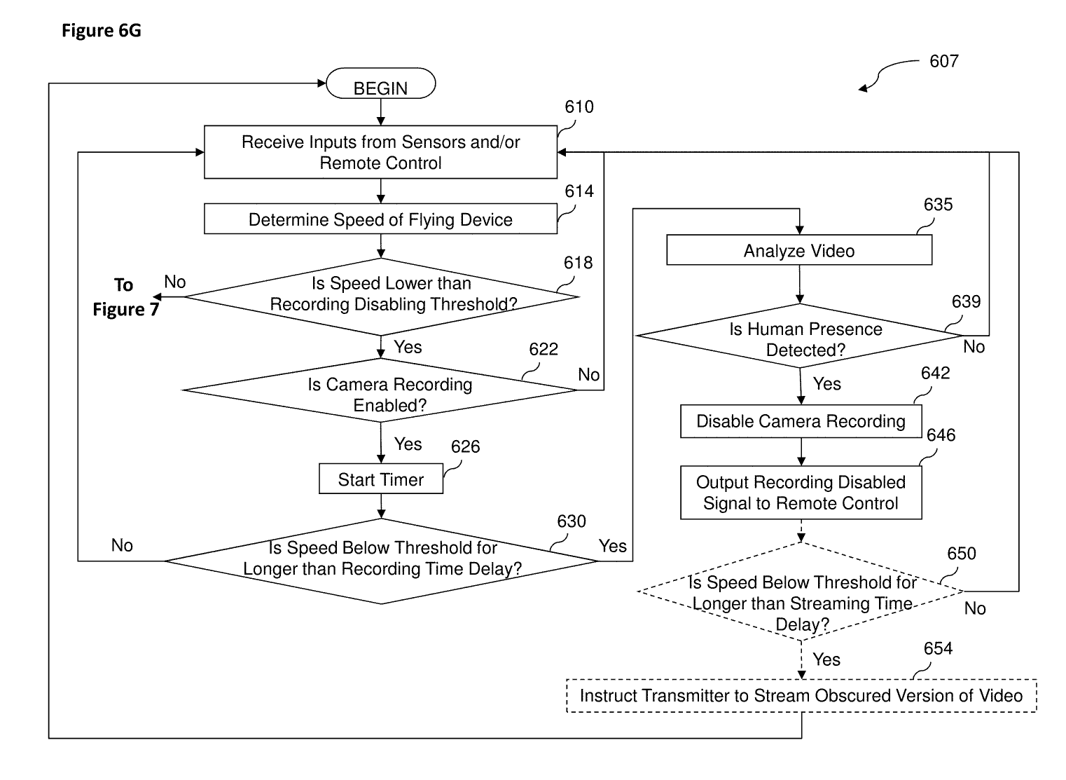

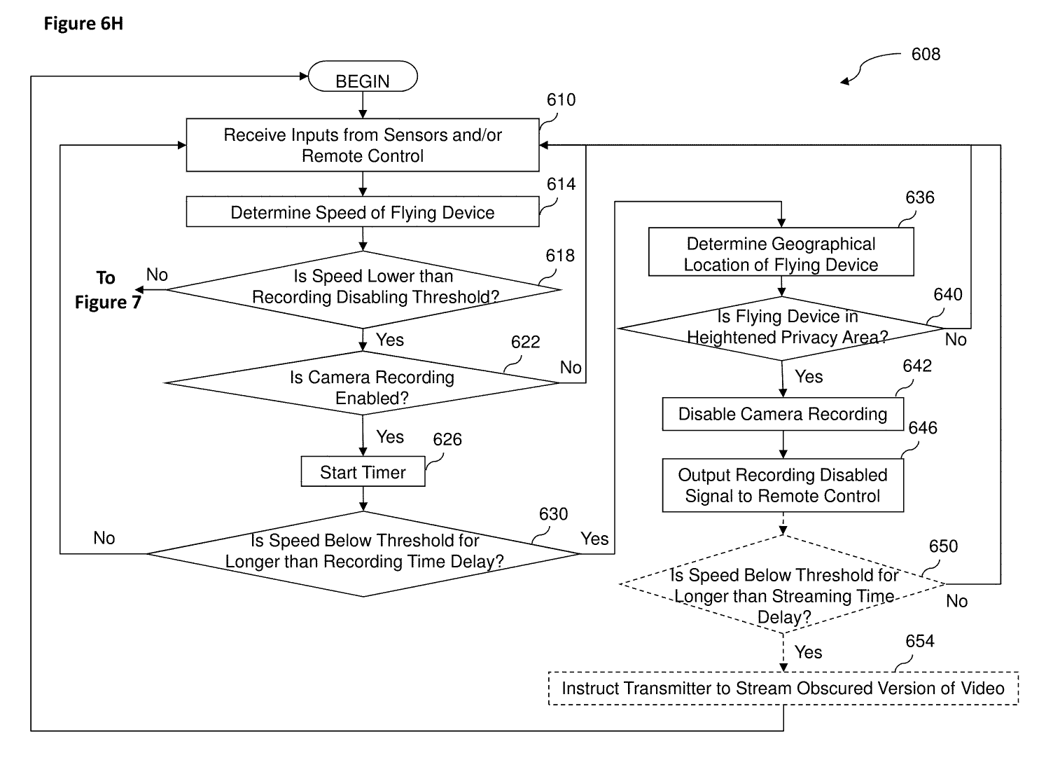

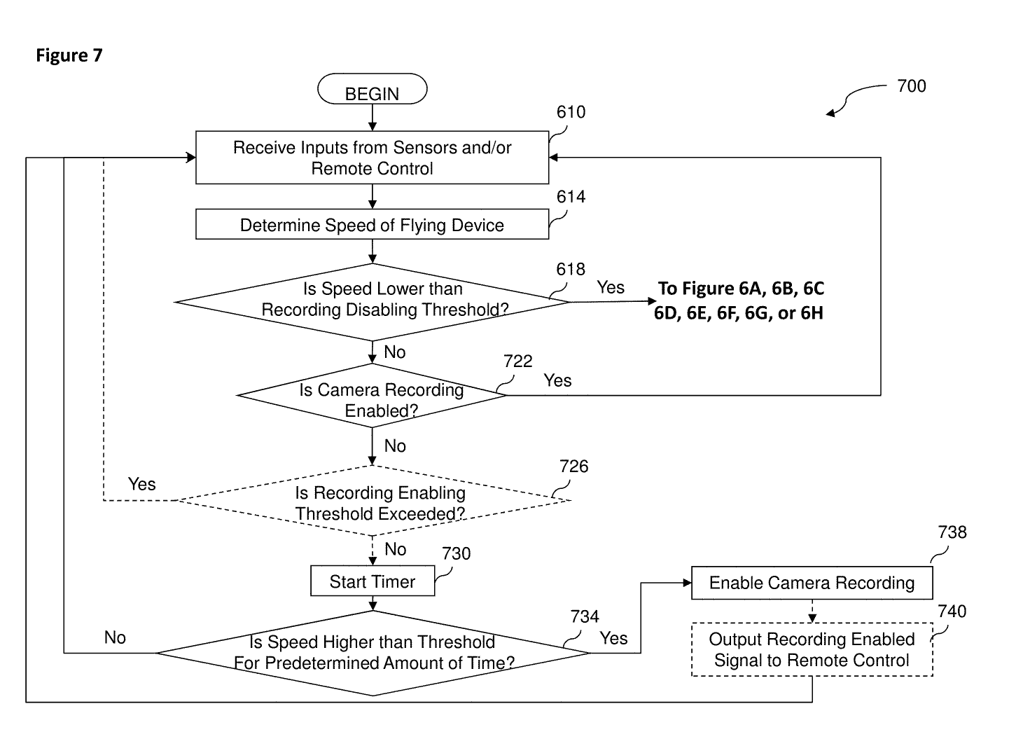

FIGS. 6A-6H and 7 illustrate example remote camera control mechanisms 601, 602, 603, 604, 605, 606, 607, 608, 700. Similar blocks in FIGS. 4A-4C and FIGS. 6A-6H and 7 can have the same or substantially the same features except as described below. Accordingly, any of the features of the mechanisms in FIGS. 4A-4C, 6A-6H, and 7 can be incorporated into one another.

As shown in FIGS. 6A-6D, the mechanisms 601, 602, 603, 604 can begin when the flying device and/or the remote control device powers on. At block 610 the controller, which can be the flying device controller or the remote control controller, receives inputs from the sensors on the flying device and/or from the remote control device. The sensors can include the motion and/or location sensors described herein, such as the GPS unit, optical sensor that is positioned to view surrounding terrain, analysis of the video feed from the camera, air pressure-based sensor, accelerometer, or any combination of such sensors. The inputs from the remote control device can include, for example, the position of joysticks, current outputs to the propellers, flight surfaces, and/or the like.

At block 614, the controller can determine the speed of the flying device. The speed can be determined from any one or a combination of the inputs in block 610. For example, the controller can estimate the speed of the flying device based on the manner with which the propellers or flight surfaces are being controlled to operate. In some embodiments, the system can take into account the wind speed or other corrections when calculating the speed of the flying device. The system can combine one or more speed determinations from various sources to improve accuracy of the calculation of the speed of the flying device, for example, by taking an average or weighted average of the one or more speed determinations, or using one of the speed signals as the primary source, such as the GPS reading, and compare with the other speed determinations to cross-check the primary source reading.

In some embodiments, the flying device controller determines the speed of the flying device in blocks 610 and 614 and transmits the speed determination to the remote control controller, which can implement the rest of the mechanisms in any of FIGS. 6A-6H and 7.

At decision block 618, the controller can determine if the speed of the flying device is lower than a recording disabling threshold. The recording disabling threshold can be between about 0 mph to about 10 mph, or about 3 mph to about 7 mph, or about 5 mph.

If the speed of the flying device is at or greater than the recording disabling threshold, the controller can proceed to the mechanism 700 in FIG. 7, which will described in greater detail below.

If the speed of the flying device is below the recording disabling threshold, at decision block 622, the controller can determine if the camera recording function is enabled. If the camera recording function has been disabled, the controller can loop back to block 610 to restart the mechanism in any of FIGS. 6A-6H and 7.

If the camera is recording, at block 626, the controller can start a timer. At decision block 630, the controller can determine if the flying device speed is below the recording disabling threshold for at least as long as a recording time delay. The recording time delay can be between about 1 second to about 60 seconds, or between about 5 seconds to about 30 seconds, or between about 10 seconds to about 20 seconds, or about 10 seconds.

If the time period when the flying device speed is below the recording disabling threshold does not exceed the recording time delay, the controller can loop back to block 610 to restart the mechanism in any of FIGS. 6A-6H and 7. If the flying device speed is below the recording disabling threshold for longer than the recording time delay, at block 642, the controller can output commands to disable camera recording, such as by disabling storing of video captured by the camera module on the data storage module or electronic memory, denying a request to begin storing the captured video on the electronic memory, or by disrupting communication with the electronic memory. At block 646, the controller can also output a notification signal to the remote control device that video recording has been disabled.

Optionally, at decision block 650, the controller can determine if the flying device speed has been below the recording disabling threshold for longer than a streaming time delay. The streaming time delay can be the same or longer than the recording time delay. The streaming time delay can be between about 5 seconds to about 60 seconds, or between about 10 seconds to about 30 seconds, or about 20 seconds. Even when the flying camera system is not able to record the video captured by the camera system when the flying device is hovering over a certain location, there can still be concerns with privacy invasion because the user is still able to view the video on the display device.

If the streaming time delay has not been exceeded, the controller can loop back to the block 610 to restart the mechanism in any of FIGS. 6A-6H and 7. If the streaming time delay has been exceeded, at block 654, the controller can optionally output commands to disable streaming of the video to the display device, such as by completely disabling the camera or by disrupting the communication between the transmitter in the flying device and the display device.

The controller can then loop back to the block 610 to restart the mechanism in any of FIGS. 6A-6H and 7.

As show in FIG. 6B, before block 642, the controller can also determine an altitude of the flying device at block 634 from the inputs received in block 610. At decision block 638, the controller can determine if the altitude of the flying device is lower than an altitude threshold. The altitude threshold can be an elevation above which there is low probability of having human presence, such as about 100 feet, or about 500 feet, or about 1,000 feet, or about 5,000 feet, or about 10,000 feet.

If the altitude of the flying device is at or above the altitude threshold, the controller can loop back to block 610 to restart the mechanism in any of FIGS. 6A-6H and 7, as it is unlikely or at least less likely that video recording by the flying camera system at that elevation can result in privacy invasion. If the attitude of the flying device is lower than the altitude threshold, the controller can advance to block 642.

As show in FIG. 6C, before block 642, the controller can also analyze the video captured by the camera module at block 635. At decision block 639, the controller can determine if human presence is detected from the video, using known facial recognition and/or other human presence detection techniques.

If the controller does not detect human presence from the video, the controller can loop back to block 610 to restart the mechanism in any of FIGS. 6A-6H and 7, as it is unlikely or at least less likely that video recording by the flying camera system at that location can result in privacy invasion. If the controller detects human presence from the video, the controller can advance to block 642.

As show in FIG. 6D, before block 642, the controller can also determine the geographical location of the flying device at block 634, for example, using the GPS unit. At decision block 638, the controller can determine if the flying device is in an area where people expect heightened privacy levels, such as at home or inside an office building.

If the controller is not in such an area, for example, if the controller is in a public place like national parks, desert, and the like, the controller can loop back to block 610 to restart the mechanism in any of FIGS. 6A-6H and 7, as it is unlikely or at least less likely that video recording by the flying camera system at that location can result in privacy invasion. If the controller is in such an area, for example, a residential neighborhood, the controller can advance to block 642.

In some embodiments, the controller can implement two or more of blocks 634, 638 of FIG. 6B, blocks 635, 639 of FIG. 6C, and/or blocks 634, 638 of FIG. 6D. The controller can advance to block 642 under any one or combination of: the flying device being below the altitude threshold, the controller detecting human presence in the video captured by the camera, and/or the flying device being in an area where people expect heightened privacy levels.

The mechanisms 605, 606, 607, 608 in FIGS. 6E-6H can be substantially the same as the mechanism 601, 602, 603, 604 in FIGS. 6A-6D except that in block 654, the controller can output commands to instruct the transmitter of the flying device to stream an obscured version of the video captured by the camera module. The obscured version can be one or more of the following: a reduced-quality version of the video captured by the camera module, a watermarked version of the video captured by the camera module, a version of the video in which human faces are obscured, or others. The obscured version can make it harder to discern certain details of the video content, thereby reducing the concerns of privacy invasion, while still allowing the user to safely navigate the flying device by avoiding obstacles.

Turning to FIG. 7, if the flying device speed is at or higher than the recording disabling threshold, at decision block 722, the controller can determine if the camera is recording. If the camera is already recording, the controller can loop back to block 610 to restart the mechanism in any of FIGS. 6A-6H and 7. If the recording has been disabled, the controller can optionally determine, at decision block 726, if the speed of the flying device exceeds a recording enabling threshold. The recording enabling threshold can be the same or different, such as higher, from the recording disabling threshold. The recording enabling threshold can be about 0 mph to about 10 mph, or about 4 mph to about 8 mph, or about 6 mph. Having the recording enabling threshold being higher than the recording disabling threshold can reduce and/or prevent transitioning between enabling and disabling of the recording function due to small fluctuations in the flying device speed.

If the recording enabling threshold is not exceeded, the controller can loop back to block 610 to restart the mechanism in any of FIGS. 6A-6H and 7. If the recording enabling threshold is exceeded, at block 730, the controller can start a timer. In decision block 734, the controller can determine if the flying device speed has exceeded the recording enabling threshold for a predetermined amount of time, which can be between about 5 seconds to about 60 seconds, or between about 10 seconds to about 30 seconds, or about 15 seconds.

If the flying device speed has exceeded the recording enabling threshold for less than the predetermined amount of time, the controller can loop back to block 610 to restart the mechanism in any of FIGS. 6A-6H and 7. If the flying device speed has exceeded the recording enabling threshold for at least the predetermined amount of time, the controller can enable the recording function at the block 738. The controller can optionally output a notification signal to the remote control device at block 740 that the recording function has been enabled.

The controller can then loop back to block 610 to restart the mechanism in any of FIGS. 6A-6H and 7.

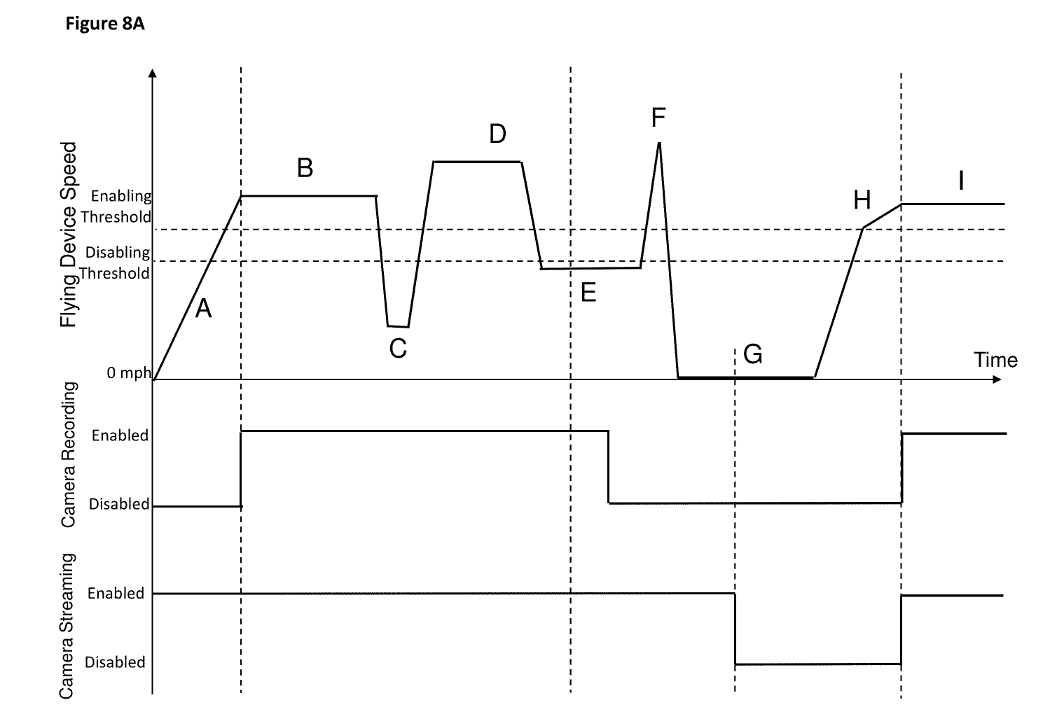

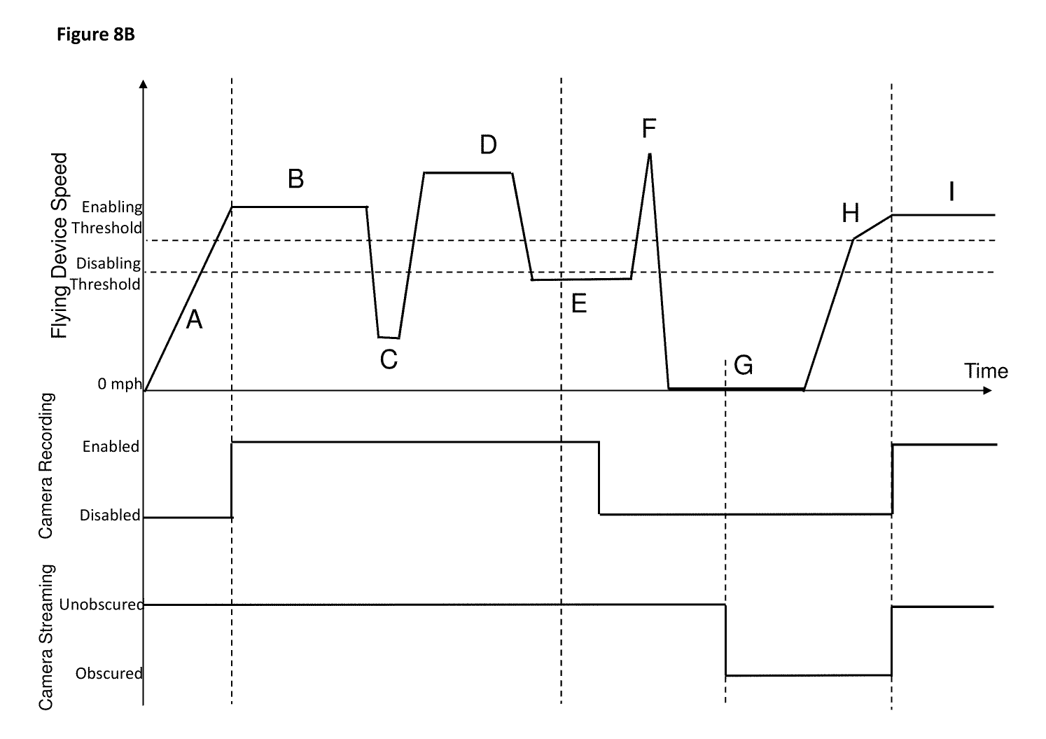

FIG. 8A illustrates various simplified control signals when implementing any of the camera control mechanisms in FIGS. 6A-6D and 7. FIG. 8B illustrates various simplified control signals when implementing any of the camera control mechanisms in FIGS. 6E-6G and 7.

In time period A, the flying device is accelerating from a substantially resting or stationary position to the recording disabling threshold and the recording enabling threshold. The camera recording is not enabled because the flying device speed has not exceeded the recording enabling threshold for at least the predetermined amount of time. In some embodiments, the camera recording function can be enabled upon powering on of the flying device.

In time period B, the camera recording function is enabled because the flying device speed has exceeded the recording enabling threshold for greater than the predetermined amount of time.

In time periods C and at least an earlier portion of time period D, the camera recording function remains enabled because the flying device speed has not fallen below the recording disabling threshold for at least the recoding time delay before the speed returns to be above the recording disabling threshold.

In a later portion of the time period D, even though the flying device speed falls below the recording disabling threshold, the camera recording function is not disabled yet because the speed has not fallen below the recording disabling threshold for at least as long as the recording time delay.

In time period E, the camera recording function is disabled because the flying device speed has fallen below the recording disabling threshold for at least as long as the recording time delay.

In time periods F and G, the camera recording function remains disabled because the flying device speed has not exceeded the recording enabling threshold for at least the predetermined amount of time before the speed returns to be below the recording disabling threshold.

In time period H, the flying device is accelerating to be above the recording disabling threshold and the recording enabling threshold. However, the camera recording is not enabled because the flying device speed has not exceeded the recording enabling threshold for at least the predetermined amount of time.

In time period I, the camera recording function is enabled because the flying device speed has exceeded the recording enabling threshold for greater than the predetermined amount of time.

Comparing the camera recording control signals in FIG. 4 with the camera recording control signal in FIGS. 8A and 8B, it can be seen that the use of one or more timers can allow the camera recording control signal to be smoother than when no timer is used. The timer(s) can prevent transitioning of the camera recording control signal between enabled and disabled due to sudden and/or temporary large changes in the flying device speed.

As shown in FIGS. 8A and 8B, the camera streaming function can be enabled and/or obscuring function can be disabled even if the camera recording function has been disabled, except in a later portion of time period G and the entire time period H. During these periods, the flying device speed has fallen below the recording disabling threshold for at least as long as the streaming time delay.

In some embodiments, streaming of the normal version of video can resume as soon as the flying device starts moving at a speed greater than the recording disabling threshold, a different threshold, or as soon as the flying device starts accelerating. In some embodiments, the controller can automatically output commands that instruct the flying device to return to its take-off location upon disabling of the streaming function. In some embodiments, the flying device can have two or more cameras and the controller can disable the streaming function of one of the cameras so that video streaming from the other camera(s) can still guide the user in safely navigating the flying device. The controller can lock the orientation of the flying device so that the streaming camera(s) cannot be rotated to take the spot of the disabled camera.

### Flying Device Embodiments

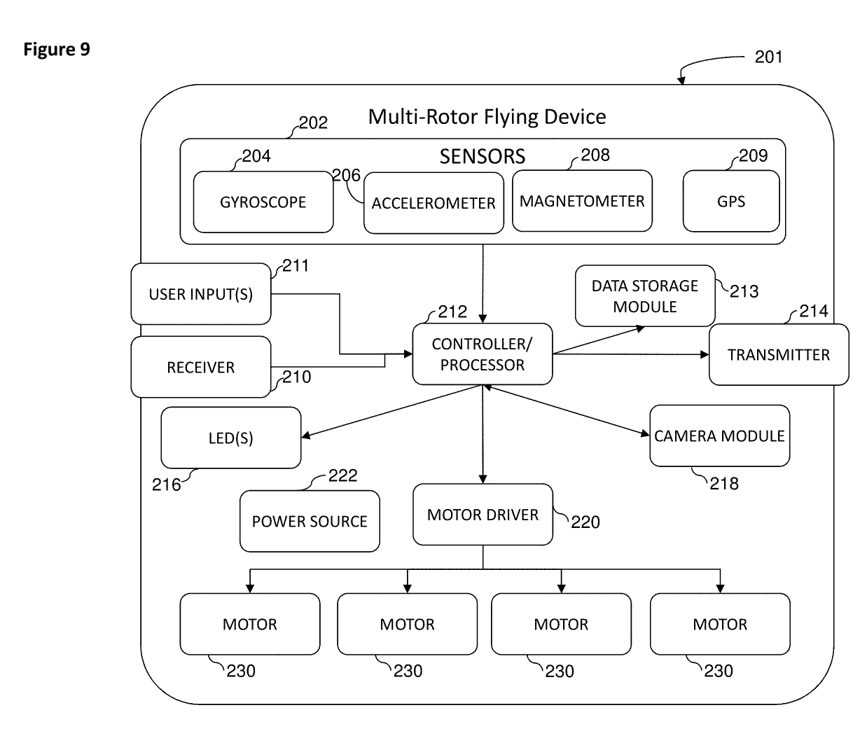

FIG. 9 illustrates an embodiment of a block diagram of a multi-rotor flying device, in this embodiment a quadcopter, which may be used with the techniques disclosed herein. Although this figure presents one embodiment of a flying device that can be used with the techniques disclosed herein, other embodiments of flying devices known in the art (for example, drones, helicopters, airplanes, and the like), and/or their associated remote control units, may be adapted to be used with the techniques disclosed herein. The multi-rotor flying device 201 comprises the following components: sensors 202; receiver 210; controller or processor 212; data storage module 213; transmitter 214; LED(s) 216; camera module 218; motor driver(s) 220; power source 222; and motor(s) 230. In other embodiments, a flying device may comprise fewer, greater, and/or different components.

The sensors 202 in the quadcopter 201 may comprise at least one or more of a gyroscope 204, accelerometer 206, magnetometer 208, GPS 209, and/or other sensors, such as an optical sensor, thermometer, barometer, altimeter, camera (infrared, visual, and/or otherwise), and/or the like. The gyroscope sensor 204 allows for the calculation and measurement of orientation and rotation of the quadcopter 201. The accelerometer 206 allows for the calculation and measurement in acceleration of the quadcopter 201. The magnetometer 208 allows for the calculation and measurement of magnetic fields and enables the quadcopter 201 to orient itself in relation to various North, South, East, West directions. The quadcopter may use one or more of the described sensors to be functional and maintain flight. The acceleration and angular velocity, and other data, measured can be used by the quadcopter 201 to assist a user in flight or record data that may be used for future flights and analysis, or the like. Other sensors may be implemented into the quadcopter 201 to measure and/or record additional statistics such as flight speed, battery level, servo motor position, or other data available through its sensors, internal components, and/or combination(s) of sensors and/or internal components. So, the quadcopter may use one or more of the described sensors to measure translational movement and/or speed.

The receiver 210 is configured to receive a signal from a remote control device. The signal may be sent via wireless radio, infrared wireless, wired, and/or the like. The received signal is then sent to the controller or processor 212 for processing and executing actions based on the received signal. Once the signal is processed, the controller 212 then send commands to the appropriate other components of the quadcopter 201. For example, the controller 212 may perform, among other things, conversion of high level flight control commands from the remote control device into low level motor control commands implement the desired flight control operations.

The system may also allow for users input(s) 211 to control various aspects or components of the system. For example, there may be one or more buttons, switches, microphones (for example, for auditory commands to be received by the user), or the like.

The controller 212 may also be used to perform certain functions while the flying device is turned on and operating that have already in programmed into the device. The programming instructions may be found in the data storage module 213 and may also have some sort of encryption or lock on the memory or instructions so that a user may be unable to access and edit such instructions. For example, there may be programmed instructions to disable the camera or functions of the camera based on the translational speed of the flying device, as measured by one or more of the described sensors.

The data storage module 213 stores information and data. The data storage module 213 may comprise read-only memory for the processor 212 to execute previously programmed functions (for example, to turn the LED light on when the quadcopter is powered on). The data storage module 213 may also or alternatively comprise writeable memory to store various programmed functions, data received from the various sensors 202, and/or the like. The data storage module 213 need not contain both types of memory, and may in fact be two or more separate elements optionally implemented. For example, the read-only memory may be incorporated and no other writable memory may be provided. Alternatively, there may be no type of memory installed and any instructions may come directly from a controller. Alternatively, there may be read-only memory installed in the quadcopter 202 and the user may install a physical memory card or chip to store additional information, if the user wishes. The data or information that would get stored in the data storage module 213 could, for example, originate from the component that created the information and go through processing prior to being written to the writable memory.

The transmitter 214 may receive data from the processor to be configured into a signal to send externally to another device, such as a remote control, computer, or remote server for storage and/or analysis. Similar to the received signal through the receive 210 as explained above, the signal sent may be via wireless radio, infrared wireless, wired, and/or the like. Although in this embodiment there are separate components for sending and receiving information (for example, a receiver 210 and a transmitter 214), some embodiments may comprise more than one receiver and/or transmitter, and/or may comprise one or more transceivers, which both receives and transmits signals.

The LED(s) 216 may be installed on the quadcopter in various locations to either indicate to the user some information that may be relevant, either through color, blinking, or brightness (for example, which end of the quadcopter is the front versus the back), or solely for aesthetic reasons alone.

The camera module 218 is a device that can be used to generate picture or video data from the quadcopter 201 during flight. The picture or video data may then be transmitted via the transceiver 214 to an external device or server or even the remote control, or the data may be stored in the data storage module 213, or both. In either situation, the camera must send the generated data to the processor 212 first, before the data is sent to the data storage module 213 or transceiver 214.

The motor driver 220 is configured to receive instructions from the processor 212 which it then uses to control the throttle and speed of the various motors 230 connected to the quadcopter 202. There may be more than one motor driver controlling the motors, however, in the present embodiment, only one is illustrated. The motor(s) 230 are connected to the motor driver 220 and receive instructions to operate at various speeds.

The power source 222 is also included in the quadcopter 201 to power each individual component. Although no line is drawn on FIG. 9 from the power source 222, each component (for example, processor, camera module, and more) desirably connects either directly or indirectly to the power source 222. This can also be done by connecting some or all devices to a circuit, or motherboard, which may contain the processor 212, and which is then connected to the power source 222. The power source 222 may be a battery (for example, Lithium Ion or Lithium Polymer battery that may be recharged, regular batteries such as AAA or AA, and/or the like), or there may be alternative power provided through other means, such as a wired connection or solar, among others.

In some embodiments, the separate components of FIG. 9 may be combined into fewer components to achieve the same purpose. For example, as stated above, the transmitter 214 and receiver 210 may be combined into one component, such as a transceiver.

### Flying Device Signal Receiving, Processing, and Executing

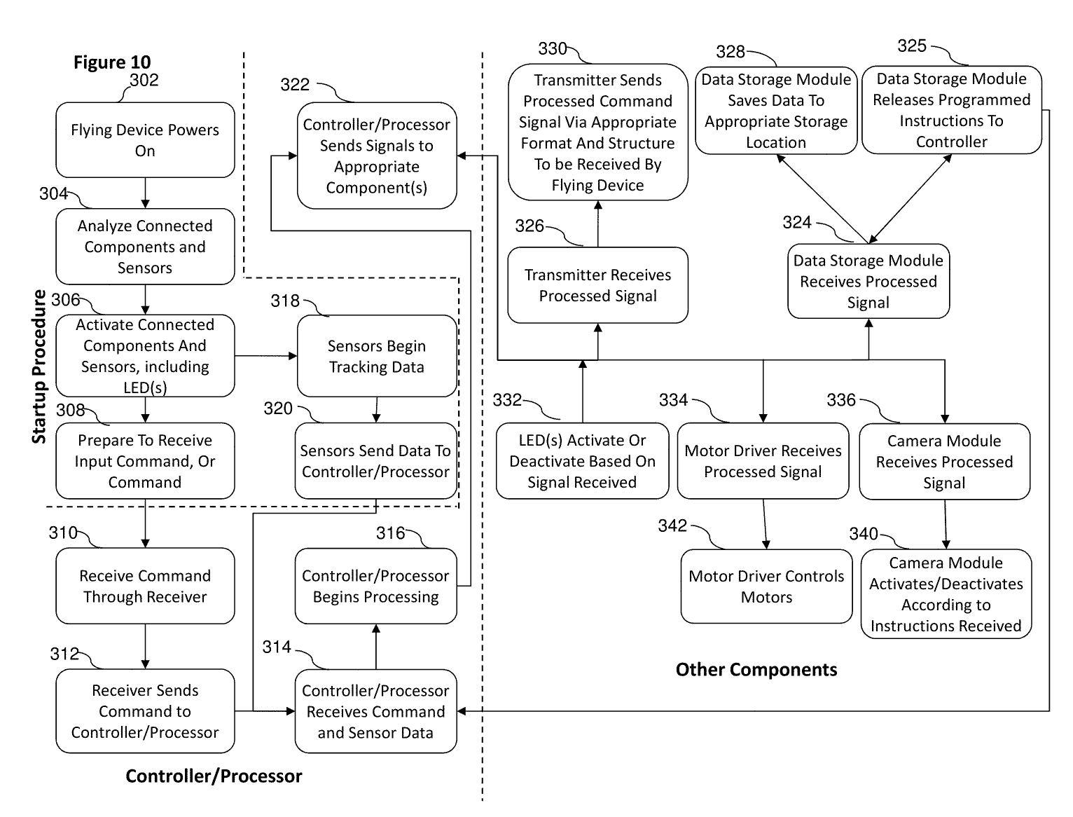

FIG. 10 illustrates a flow chart diagram of one embodiment of a process that a flying device may take upon receipt to process and execute a signal. Many of the methods and systems described herein may produce the same results with either software programming, mechanical means, or through circuitry. It is not a requirement to use one means over another to achieve the same result. However, where one method is impractical, or not possible to implement without great expense flying device, to one skilled in the art, then the more practical approach would be the preferred approach.

Blocks 302 through 308, and 318 and 320, pertain to a general startup procedure of the flying device. At block 302 the flying device powers on. This may be achieved by the user pressing a button, speaking a command (if a microphone is implemented in the device), flipping a switch, touching a sensor, based on pre-set conditions (for example, time or temperature), receipt of an “on” signal command from another device, or the like.

At block 304, the flying device analyzes the connected components (either internal or external). The controller acknowledges which components are connected. Also, in some embodiments, the analysis of connected components may not be necessary; however, any equivalent analysis method may be inherent within the device (for example, the circuitry may be indicative of any connected components). Connected components may include sensors, cameras, microphones, speakers, receivers (for example, IR, radio, or the like), data storage modules (for example, internal memory or user input memory, such as an SD card), transmitter, motor driver, motors, LED(s), among others.

At block 306, the flying device activates connected components. In some embodiments the flying device may only activate the components that assist in flying to conserve power. For example, any external LED(s) may remain turned off until the user chooses. Another example would be to keep the camera turned off until the user chooses to activate it.

At block 318, the activated sensors begin tracking data in preparation for flight.

At block 320, the activated sensors begin to send data from tracking to the controller/processor.

At block 308, the flying device does any last required steps in order to prepare to receive an input command from a remote control. Steps may include anything necessary to function or the steps may be completely for user preference (for example, special lighting scheme or auditory confirmation that the device is ready).

At block 310, the flying device receives a command through its receiver. The command received may be received through a physical touch by a user, or through any other means (for example, voice, or motion of the controller).

At block 312, the receiver of the flying device sends the received command to the controller or processor. In some embodiments, the flying device will convert the received command into an appropriate signal. For example, in several embodiments, the command may need to be converted into an electrical signal.

At block 314, the controller in the flying device receives the command and various sensor data. In some embodiments, the data the controller receives may include programmed instructions which may be located in the data storage module as described in block 325.

At block 316, the controller in the flying device processes the command and various sensor data. Processing may include analysis of the sensor data and command to send signals to the various components to either: activate, manipulate, or deactivate them. In some embodiments, data received by the controller may also then be written to memory in a data storage module (for example, an internal memory or user input memory, such as an SD card). Additionally, in some embodiments, the controller may also send data to a transmitter to be sent to an external device. Such data may be helpful for tracking, flight, or diagnostics (whether real-time or not).

At block 322, after processing completes, and if required, signals are sent to various components to either: activate, manipulate, or deactivate them. Not all components are necessarily communicated to at the same time. Such components may include, but are limited by: a data storage module, a transmitter, LED(s), a camera module, and a motor driver. Signals may be generated by the controller itself based on programmed criteria (see block 325), or by a user through a controller.

At block 324, the data storage module receives a processed signal from the controller. At block 326, the data storage module accordingly stores any information directed by the controller to the appropriate storage medium. At block 325, the data storage module releases, or allows access to, programmed instructions for the controller to execute in block 322. Such instructions may include activating or deactivating certain components at specific times or under certain programmed circumstances. The circumstances may vary depending on the wishes of the user or manufacturer who programs the instructions into the device. For example, the manufacturer may store instructions for the device to keep the camera module deactivated until sensor data from one or more of the various sensors indicate to the controller that the flying device is translationally moving at or above the programmed minimum speed. The stored instructions may be encrypted and/or uneditable by a user. The programmed instructions stored on the data module are always accessible by the controller while the device is in use.

At block 328, the transmitter receives a processed signal from the controller. At block 330, the transmitter sends the processed signal after any further preparation that may be required. For example, in some embodiments, any sent signal may need to be formatted or converted to a different type of signal (for example, electrical to some type of wireless signal).

At block 332, any connected LED(s) may receive a processed signal from the controller will either activate or deactivate depending on the signal received and the current state of the LED (for example, whether the LED is currently activated or deactivated). For example, in some embodiments, the LED(s) may illuminate to show the user relevant information for flight (for example, the flying device is powered on, or which direction is the front or back of the flying device) or information unrelated to flight (for example, a light show for entertainment purposes).

At block 336, the camera module received a processed signal from the controller. At block 340, the camera module will activate or deactivate according to the instructions received. This activation may involve some sort of picture or video recording. For example, the camera may snap 1 picture, a burst of pictures, record in slow-motion, or record regular video. The camera may also record or take pictures in varying resolution, or with other varying settings. In some embodiments, there may also be a preset default mode on how to take pictures or record video. The camera module, in some embodiments, may also send data back to the controller to either be saved in the data storage module and/or be transmitted externally via a transceiver. In some embodiments, the camera module may be deactivated under a programmed set of instructions, which may be stored in the data storage module and accessed by the controller upon startup.

At block 334, the motor driver receives a processed signal from the controller. In some embodiments, there may be only one motor driver, and in other embodiments there may be more than one. At block 342, the motor driver will activate and send a signal to specific motor(s) in the system. For example, a quadcopter would have four motors to be controlled and at least one will be sent a signal. The signal will force the connected motor(s) to either: turn on, change speed, or turn off. Several motors may receive the same or different signals at the same time. For example, in some embodiments, a change in throttle instruction for a quadcopter would provide the same signal to all motors so that the flying device will increase in elevation. Also, in other embodiments, a change in pitch instruction for a quadcopter would provide a different signal to the two front motors than to the two back motors.

Other Remarks

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the disclosures or claims.

In some embodiments, the techniques disclosed herein related to wireless control of a flying device and/or dynamic configurability of a controller are technically impossible to perform by a human being and/or require the use of a computing device. For example, to enable a reasonable level of controllability of the flying device, it can be desirable to reduce lag time or latency between movement of user inputs on the controller and corresponding flight control adjustments made by the flying device. It can be desirable for these adjustments to occur in real time or substantially in real time, such as, for example, with a lag time or latency of no greater than 1, 5, 10, 20, 50, or 100 milliseconds. Further, if a user wishes to switch the present control mode of the controller while the flying device is in flight, it can be desirable to minimize the amount of time it takes to switch modes, so that, for example, the flying device does not crash or otherwise operate undesirably while the mode switch is being made. This dynamic switch of modes can desirably occur in real time or substantially in real time, such as, for example, with a lag time or latency of no greater than 1, 5, 10, 20, 50, or 100 milliseconds.

The term, “Real-time,” can mean any time that is seemingly, or near, instantaneous such that a practiced user of a remote control unit, that is using such remote control unit to operate a flying device, would be able to still fly the device. There is inherently a very small delay in the creation and transmission of a signal by a remote control unit added to another very small inherent delay in the receipt, processing, and execution of that received signal in a flying device. The very small delay is typically a fraction of a second, but may even exceed a second in some circumstances. The delay may also depend on the physical properties of light or other physical phenomenon. The term, “Real-time,” encompasses all instances of delay to a point where a practiced user of a remote control unit can still maintain flight of a flying device.

Any ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately,” “about,” and “substantially” as used herein include the recited numbers, and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

Although the features that have been disclosed in the context of certain preferred embodiments and examples, it will be understood by those skilled in the art that the present disclosure extends beyond the specifically disclosed embodiments to other alternative embodiments and/or uses of the disclosure and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present disclosure herein disclosed should not be limited by the particular disclosed embodiments described above.

1. A remotely controlled flying video recording system comprising:
a body having one or more propulsion units coupled thereto for causing flight of the remotely controlled flying video recording system;
a radio receiver configured to receive command signals from a remote transmitter, the command signals comprising at least flight control data configured to adjust operation of the one or more propulsion units;
a camera configured to capture video;
an electronic memory controller configured to be electronically coupled to an electronic memory for storing video captured by the camera on the electronic memory;
a radio transmitter configured to stream video captured by the camera to a remote video display device;
a speed sensor configured to detect a speed of the remotely controlled flying video recording system; and
a video controller configured to:
communicate with the speed sensor to monitor the speed of the remotely controlled flying video recording system;
compare the speed of the remotely controlled flying video recording system to a threshold speed level; and
responsive to determining the speed is below the threshold speed level, disable storing of video captured by the camera on the electronic memory.

2. The remotely controlled flying video recording system of claim 1, wherein the video controller is further configured to:
responsive to determining the speed is below the threshold speed level, cause the radio transmitter to transmit to the remote video display device an indication that storing of video has been disabled or cause transmission to the remote transmitter data indicating a request to begin storing of video captured by the camera has been denied.

3. The remotely controlled flying video recording system of claim 1, wherein the video controller is configured to enable the radio transmitter to continue streaming video captured by the camera to the remote video display device, even if the video controller has disabled storing of video captures by the camera on the electronic memory.

4. The remotely controlled flying video recording system of claim 1, wherein the video controller is further configured to:
monitor an amount of time the speed has been below the threshold speed level;
compare the amount of time the speed has been below the threshold speed level to a recording time delay; and
responsive to determining the speed is below the threshold speed level, disable storing of video captured by the camera on the electronic memory only if the amount of time the speed has been below the threshold speed level exceeds the recording time delay.

5. The remotely controlled flying video recording system of claim 4, wherein the video controller is further configured to:
compare the amount of time the speed has been below the threshold speed level to a streaming time delay, the streaming time delay being greater than the recording time delay; and
responsive to determining the speed is below the threshold speed level, and that the amount of time the speed has been below the threshold speed level exceeds the streaming time delay, disable the radio transmitter from streaming video captured by the camera to the remote video display device.

6. The remotely controlled flying video recording system of claim 4, wherein the video controller is further configured to:
compare the amount of time the speed has been below the threshold speed level to a streaming time delay, the streaming time delay being greater than the recording time delay; and
responsive to determining the speed is below the threshold speed level, and that the amount of time the speed has been below the threshold speed level exceeds the streaming time delay, cause the radio transmitter to stream an obscured version of video captured by the camera to the remote video display device,
wherein the obscured version comprises one or more of the following: a reduced-quality version of the video captured by the camera, or a watermarked version of the video captured by the camera.

7. The remotely controlled flying video recording system of claim 1, wherein the video controller is further configured to:
analyze video captured by the camera to detect whether a human is present in the video captured by the camera; and
responsive to determining the speed is below the threshold speed level, disable storing of video captured by the camera on the electronic memory only if a human is present in the video captured by the camera.

8. The remotely controlled flying video recording system of claim 1, further comprising:
an altitude sensor configured to detect an altitude of the remotely controlled flying video recording system; and
wherein the video controller is further configured to:
communicate with the altitude sensor to monitor the altitude of the remotely controlled flying video recording system;
compare the altitude of the remotely controlled flying video recording system to a threshold altitude level; and
responsive to determining the speed is below the threshold speed level, disable storing of video captured by the camera on the electronic memory only if the altitude of the remotely controlled flying video recording system is below the threshold altitude level.

9. The remotely controlled flying video recording system of claim 1, wherein the speed sensor comprises a Global Positioning System (GPS) sensor, a pressure sensor, an optical sensor, and/or an accelerometer.

10. The remotely controlled flying video recording system of claim 1, further comprising the electronic memory.

11. (canceled)

12. (canceled)

13. The remotely controlled flying video recording system of claim 1, wherein the remote transmitter comprises the remote video display device.

14. (canceled)

15. (canceled)

16. (canceled)

17. A remotely controlled flying video recording system comprising:
a body having one or more propulsion units coupled thereto for causing flight of the remotely controlled flying video recording system;
a radio receiver configured to receive command signals from a remote transmitter, the command signals comprising at least flight control data configured to adjust operation of the one or more propulsion units;
a camera configured to capture video;
a radio transmitter configured to stream video captured by the camera to a remote video display device; and
a video controller configured to:
receive output of signals indicative of a speed of the remotely controlled flying video recording system;
compare the speed of the remotely controlled flying video recording system to a threshold speed level; and
responsive to determining the speed is below the threshold speed level, disable storing of video captured by the camera on an electronic memory.

18. (canceled)

19. The remotely controlled flying video recording system of claim 17, wherein the video controller is configured to enable the radio transmitter to continue streaming video captured by the camera to the remote video display device, even if the video controller has disabled storing of video captures by the camera on the electronic memory.

20. The remotely controlled flying video recording system of claim 17, wherein the video controller is further configured to:
monitor an amount of time the speed has been below the threshold speed level;
compare the amount of time the speed has been below the threshold speed level to a recording time delay; and
responsive to determining the speed is below the threshold speed level, disable storing of video captured by the camera on the electronic memory only if the amount of time the speed has been below the threshold speed level exceeds the recording time delay.

21. The remotely controlled flying video recording system of claim 20, wherein the video controller is further configured to:
compare the amount of time the speed has been below the threshold speed level to a streaming time delay, the streaming time delay being greater than the recording time delay; and
responsive to determining the speed is below the threshold speed level, and that the amount of time the speed has been below the threshold speed level exceeds the streaming time delay, disable the radio transmitter from streaming video captured by the camera to the remote video display device.

22. The remotely controlled flying video recording system of claim 20, wherein the video controller is further configured to:
compare the amount of time the speed has been below the threshold speed level to a streaming time delay, the streaming time delay being greater than the recording time delay; and
responsive to determining the speed is below the threshold speed level, and that the amount of time the speed has been below the threshold speed level exceeds the streaming time delay, cause the radio transmitter to stream an obscured version of video captured by the camera to the remote video display device,
wherein the obscured version comprises one or more of the following: a reduced-quality version of the video captured by the camera, or a watermarked version of the video captured by the camera.

23. The remotely controlled flying video recording system of claim 17, wherein the video controller is further configured to:
analyze video captured by the camera to detect whether a human is present in the video captured by the camera; and
responsive to determining the speed is below the threshold speed level, disable storing of video captured by the camera on the electronic memory only if a human is present in the video captured by the camera.

24. The remotely controlled flying video recording system of claim 17, further comprising:
an altitude sensor configured to detect an altitude of the remotely controlled flying video recording system; and
wherein the video controller is further configured to:
communicate with the altitude sensor to monitor the altitude of the remotely controlled flying video recording system;
compare the altitude of the remotely controlled flying video recording system to a threshold altitude level; and
responsive to determining the speed is below the threshold speed level, disable storing of video captured by the camera on the electronic memory only if the altitude of the remotely controlled flying video recording system is below the threshold altitude level.

25. The remotely controlled flying video recording system of claim 17, wherein the output of signals indicative of the speed of the remotely controlled flying video recording system comprise signals from a motion sensor, an optical sensor, a pressure sensor, a video feed from the camera, a propulsion unit power and/or current output, user input on a remote control device, and/or any combination thereof.

26. The remotely controlled flying video recording system of claim 25, wherein the motion sensor comprises electrical and/or mechanical sensors.

27.-46. (canceled)
